(19) United States
(12) Patent Application Publication
(10) Pub. No.: US 2012/0062593 A1
(43) Pub. Date: Mar. 15, 2012

(54) IMAGE DISPLAY APPARATUS

(75) Inventor: Kazuhiro KOJIMA, Osaka (JP)

(73) Assignee: SANYO ELECTRIC CO., LTD., Osaka (JP)

(21) Appl. No.: 13/232,328

(22) Filed: Sep. 14, 2011

(30) Foreign Application Priority Data
Sep. 14, 2010 (JP) 2010-205425
Aug. 3, 2011 (JP) 2011-169760

(51) Int. Cl. G09G 5/00

(52) U.S. Cl. 345/629

(57) ABSTRACT

An image display apparatus includes an image display portion that displays a display image based on a reference image on a display screen, a pointing member detecting portion that detects a position of a pointing member existing on the display screen of the image display portion, and an output image processing portion that generates an output image to be displayed on the display screen based on the reference image. The output image processing portion is capable of generating a superposition image as the output image, in which an auxiliary image including a specific region in the reference image corresponding to the position of the pointing member detected by the pointing member detecting portion is superposed on a region for superposition different from the specific region in the reference image.

### CROSS-REFERENCE TO RELATED APPLICATIONS

This nonprovisional application claims priority under 35 U.S.C. §119(a) on Patent Application No. 2010-205425 filed in Japan on Sep. 14, 2010 and on Patent Application No. 2011-169760 filed in Japan on Aug. 3, 2011, the entire contents of which are hereby incorporated by reference.

### BACKGROUND OF THE INVENTION

1. Field of the Invention

The present invention relates to an image display apparatus that displays an image.

2. Description of Related Art

An image display apparatus adopting a touch panel as a user interface is widely used. In this image display apparatus, a user designates a desired position on the touch panel (in the displayed image) with a pointing member such as a finger of the user or a stylus, as an intuitive operation.

For instance, as a conventional method, there is proposed an image display apparatus having improved usability of the touch panel. This image display apparatus enlarges and displays a region of an image designated by the user, and further receives an instruction from the user with respect to the enlarged display region so that the user can easily designate a desired position in the image.

In addition, for example, as another conventional method, there is proposed an image display apparatus in which an image obtained by imaging and an enlarged image of a part of the image are displayed simultaneously, and hence the user can easily check a change in the image due to a change of imaging conditions such as focus. In addition, for example, there is also proposed a method in which a main screen and a sub screen are disposed independently in a display portion, so that an image of a region in the main screen is displayed in the sub screen.

When the user operates the touch panel to designate a desired position in the image, it is necessary to put a pointing member at a region on the touch panel displaying the position. In this case, a line of sight of the user looking at the region on the touch panel may be interrupted by the pointing member or a user's hand. Therefore, it becomes difficult for the user to view the designated position and its vicinity in the image displayed on the touch panel. For instance, it becomes difficult for the user to grasp whether or not a desired image is obtained by the touch panel operation, or whether or not an intended position is designated correctly by the pointing member.

Therefore, for example, the user has to view the touch panel from various angles during the touch panel operation, or to often remove the pointing member from the position where the touch panel operation is being performed (to perforin the operation intermittently). In this way, the conventional touch panel has insufficient usability, which is a problem. Note that even the touch panel enlarges and displays a part of the image like the above-mentioned image display apparatus, the user still has to put the pointing member at a desired region on the touch panel (on the enlarged and displayed region) when the user operates the touch panel. Therefore, the above-mentioned problem is not solved. In addition, if the method of disposing a sub screen, a display size of the main screen to display the entire image is decreased. Therefore, visibility of the entire image is deteriorated.

### SUMMARY OF THE INVENTION

An image display apparatus according to an aspect of the present invention includes an image display portion that displays a display image based on a reference image on a display screen, a pointing member detecting portion that detects a position of a pointing member existing on the display screen of the image display portion, and an output image processing portion that generates an output image to be displayed on the display screen based on the reference image. The output image processing portion is capable of generating a superposition image as the output image, in which an auxiliary image including a specific region in the reference image corresponding to the position of the pointing member detected by the pointing member detecting portion is superposed on a region for superposition different from the specific region in the reference image.

Meanings and effects of the present invention will be more apparent from the following description of an embodiment. However, the following embodiment is merely one of embodiments of the present invention, and the meaning of the present invention and terms of elements thereof are not limited to those described in the following embodiment.

### BRIEF DESCRIPTION OF THE DRAWINGS

FIG. 1 is a block diagram illustrating a structural example of an image pickup apparatus as an embodiment of the present invention.

FIGS. 2A and 2B are diagrams illustrating display screens of an image display portion on which output images are displayed.

FIG. 3 is a block diagram illustrating a structural example of an output image processing portion.

FIG. 4 is a table showing an action example (A1) of a pointing member information correcting portion.

FIG. 5 is a table showing an action example (A2) of the pointing member information correcting portion.

FIG. 6 is a table showing an action example (A3) of the pointing member information correcting portion.

FIG. 7 is a table showing an action example (B1) of an auxiliary image display control portion.

FIG. 8 is a table showing an action example (B2) of the auxiliary image display control portion.

FIG. 9 is a table showing an action example (B3) of the auxiliary image display control portion.

FIG. 10 is a diagram illustrating an action example (C1) of an image processing execution portion.

FIG. 11 is a diagram illustrating an action example (C2) of the image processing execution portion.

FIG. 12 is a diagram illustrating the action example (C2) of the image processing execution portion.

FIG. 13 is a diagram illustrating an action example (C3) of the image processing execution portion.

FIG. 14 is a diagram illustrating an action example (D1) of an auxiliary image superposing portion.

FIG. 15 is a diagram illustrating an action example (D2) of the auxiliary image superposing portion.

FIGS. 16A to 16C are diagrams illustrating a first action example of the output image processing portion.

FIGS. 17A to 17C are diagrams illustrating a second action example of the output image processing portion.

FIGS. 18A to 18C are diagrams illustrating a third action example of the output image processing portion.

FIGS. 19A and 19B are diagrams illustrating a fourth action example of the output image processing portion.

FIGS. 20A to 20D are diagrams illustrating the fourth action example of the output image processing portion.

FIG. 21 is a diagram illustrating the fourth action example of the output image processing portion.

FIGS. 22A to 22D are diagrams illustrating a fifth action example of the output image processing portion.

FIGS. 23A to 23E are diagrams illustrating a sixth action example of the output image processing portion.

### DETAILED DESCRIPTION OF THE PREFERRED EMBODIMENTS

An embodiment of the present invention is described below with reference to the attached drawings. First, an image pickup apparatus as one form of the embodiment of the present invention is described. Note that the image pickup apparatus described below is a digital camera or the like that can generate, record, and display an image (including a moving image (individual frames) and a still image, and the same is true in the following description) signal, and can generate, record, and reproduce a sound signal.

<<Image Pickup Apparatus>>

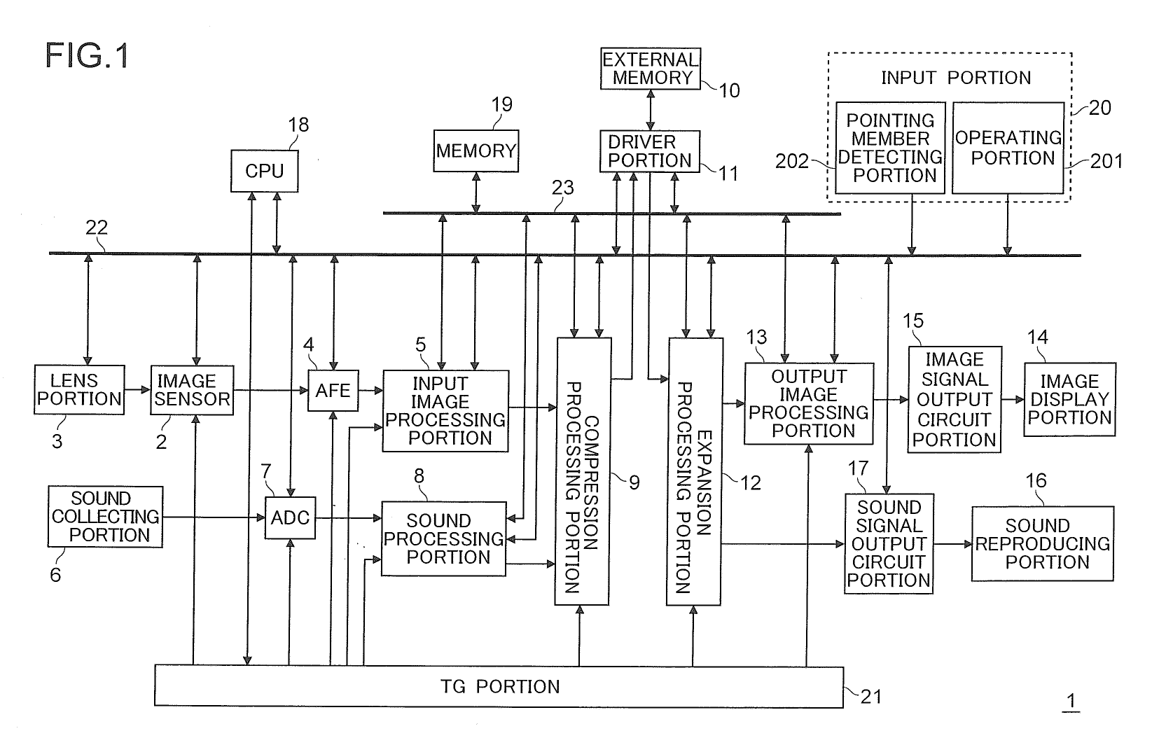

First, a structural example of the image pickup apparatus including a touch panel as an embodiment of the present invention is described with reference to FIG. 1. FIG. 1 is a block diagram illustrating a structural example of the image pickup apparatus as an embodiment of the present invention.

As illustrated in FIG. 1, an image pickup apparatus 1 includes an image sensor 2 constituted of a solid-state image sensor such as a charge coupled device (CCD) or a complementary metal oxide semiconductor (CMOS) sensor that converts an incident optical image into an image signal as an electric signal, and a lens portion 3 that forms an optical image of a target object on the image sensor 2 and adjusts light intensity and the like. The lens portion 3 is equipped with various lenses (not shown) such as a zoom lens and a focus lens, and an aperture stop (not shown) that adjusts light intensity entering the image sensor 2.

Further, the image pickup apparatus 1 includes an analog front end (AFE) 4 that converts an analog image signal output from the image sensor 2 into a digital signal and adjusts a gain, an input image processing portion 5 that performs various image processing operations such as a gradation correction process on the image signal output from the AFE 4, a sound collecting portion 6 that converts input sound into a sound signal as an electric signal, an analog to digital converter (ADC) 7 that converts an analog sound signal output from the sound collecting portion 6 into a digital signal, a sound processing portion 8 that performs various sound processing operations such as noise reduction on the sound signal output from the ADC 7 and outputs the result, a compression processing portion 9 that performs a compression encoding process for moving image such as the Moving Picture Experts Group (MPEG) compression encoding method on the image signal output from the input image processing portion 5 and the sound signal output from the sound processing portion 8, and performs a compression encoding process for still image such as the Joint Photographic Experts Group (JPEG) compression encoding method on the image signal output from the input image processing portion 5, an external memory 10 that stores a compression encoded signal that is compressed and encoded by the compression processing portion 9, a driver portion 11 that records and reads the compression encoded signal in or from the external memory 10, and an expansion processing portion 12 that expands and decodes the compression encoded signal read out from the external memory 10 by the driver portion 11.

In addition, the image pickup apparatus 1 includes an output image processing portion 13 that performs a predetermined process on the image signal decoded by the expansion processing portion 12 and the image signal output from the input image processing portion 5, an image display portion 14 constituted of a monitor or the like that displays the image signal on a display screen, an image signal output circuit portion 15 that converts the image signal output from the output image processing portion 13 into an image signal of a format that can be displayed on the image display portion 14, a sound reproducing portion 16 constituted of a speaker or the like that reproduces the sound signal, and a sound signal output circuit portion 17 that converts the sound signal decoded by the expansion processing portion 12 into a sound signal of a format that can be reproduced by the sound reproducing portion 16. Note that details of the structure of the output image processing portion 13 will be described later.

In addition, the image pickup apparatus 1 includes a central processing unit (CPU) 18 that controls actions of the entire image pickup apparatus 1, a memory 19 for storing programs for performing processes and for temporarily storing data when the program is executed, an input portion 20 constituted of an operating portion 201, a pointing member detecting portion 202 and the like, which receives an instruction from a user, a timing generator (TG) portion 21 that outputs a timing control signal for synchronizing action timings of the individual portions, a bus 22 for data communication between the CPU 18 and each block, and a bus 23 for data communication between the memory 19 and each block. Note that in the following description, the buses 22 and 23 are neglected in communication with each block for simple description.

The operating portion 201 includes a plurality of buttons, for example, and detects various instruction inputs such as start or end of imaging when the user presses the button. The pointing member detecting portion 202 includes a detection film disposed on the display screen of the image display portion 14, for example, so as to detect contact or approach of the pointing member as a capacitance variation or a resistance variation, and hence the pointing member detecting portion 202 detects a position of the pointing member existing on the display screen of the image display portion 14 or an area of the same (an area occupied by the pointing member on the display screen of the image display portion 14, and for example, a contact area of the pointing member with the detection film). In addition, the image display portion 14 and the pointing member detecting portion 202 constitute the touch panel.

Next, an action example of the image pickup apparatus 1 is described with reference to FIG. 1. First, the image pickup apparatus 1 obtains an image signal as an electric signal by photoelectric conversion (imaging) in the image sensor 2 of light entering from the lens portion 3. Then, the image sensor 2 outputs the image signal to the AFE 4 at a predetermined timing in synchronization with the timing control signal supplied from the TG portion 21.

Then, the image signal converted from analog to digital by the AFE 4 is supplied to the input image processing portion 5. The input image processing portion 5 converts the input image signal having red (R), green (G) and blue (B) components into an image signal having components of a luminance signal (Y) and color difference signals (U, V), and performs various image processing operations such as gradation correction or edge enhancement. In addition, the memory 19 works as a frame memory and holds the image signal temporarily when the input image processing portion 5 performs processing.

In addition, in this case, based on the image signal supplied to the input image processing portion 5, the lens portion 3 adjusts a lens position so that focus adjustment is performed and adjusts an opening degree of the aperture stop so that exposure is adjusted. These adjustments of focus and exposure are performed automatically to be optimal states based on a predetermined program (automatic focus and automatic exposure), or are performed manually based on instructions from the user.

When an image signal of the moving image is generated, the sound collecting portion 6 performs sound collection. The sound signal, which is collected by the sound collecting portion 6 and is converted into the analog electric signal, is supplied to the ADC 7. The ADC 7 converts the supplied sound signal into a digital signal, which is supplied to the sound processing portion 8. The sound processing portion 8 performs various sound processing operations such as noise reduction and intensity control on the supplied sound signal. Then, both the image signal output from the input image processing portion 5 and the sound signal output from the sound processing portion 8 are supplied to the compression processing portion 9, and are compressed and encoded by a predetermined compression encoding method in the compression processing portion 9. In this case, the image signal and the sound signal are associated with each other in a temporal manner, so that a shift between image and sound does not occur in reproduction. Then, the compression encoded signal output from the compression processing portion 9 is recorded in the external memory 10 via the driver portion 11. On the other hand, when an image signal of a still image is generated, the image signal output from the input image processing portion 5 is supplied to the compression processing portion 9, and is compressed and encoded by a predetermined compression encoding method in the compression processing portion 9. Then, the compression encoded signal output from the compression processing portion 9 is recorded in the external memory 10 via the driver portion 11.

The compression encoded signal of the moving image recorded in the external memory 10 is read out by the expansion processing portion 12 based on an instruction from the user. The expansion processing portion 12 expands and decodes the compression encoded signal so as to generate and output the image signal and the sound signal. In addition, the expansion processing portion 12 decodes the compression encoded signal of the still image recorded in the external memory 10 in the same manner, so as to generate and output the image signal.

The image signal output from the expansion processing portion 12 is supplied to the output image processing portion 13. In addition, before recording or during recording of the image signal, the image signal obtained by imaging is displayed on the display screen of the image display portion 14 and is viewed by the user. In this case, the image signal output from the input image processing portion 5 is supplied to the output image processing portion 13 via the bus 22. The output image processing portion 13 performs a predetermined process on the input image signals and then supplies the image signals to the image signal output circuit portion 15. Note that it is possible that the image signal output from the output image processing portion 13 is supplied to the compression processing portion 9, and is compressed and encoded so that the obtained compression encoded signal is recorded in the external memory 10 via the driver portion 11. In addition, details of action of the output image processing portion 13 will be described later.

The image signal output circuit portion 15 converts the image signal output from the output image processing portion 13 into a format that can be displayed on the image display portion 14, and outputs the result. In addition, the sound signal output circuit portion 17 converts the sound signal output from the expansion processing portion 12 into a format that can be reproduced by the sound reproducing portion 16, and outputs the result.

Note that the image pickup apparatus 1 capable of generating image signals of a moving image and a still image is described above as an example, but it is possible that the image pickup apparatus 1 has a structure capable of generating only one of the image signals of the moving image and the still image.

In addition, the structure may not have at least one of the function related to collection of a sound signal (e.g., the sound collecting portion 6, the ADC 7, the sound processing portion 8, and a part of the compression processing portion 9 related to a sound signal) and a function related to reproduction of a sound signal (e.g., a part of the expansion processing portion 12 related to a sound signal, the sound reproducing portion 16, and the sound signal output circuit portion 17). In addition, the structure may not have a function related to imaging (e.g., the image sensor 2, the lens portion 3, the AFE 4, the input image processing portion 5, and a part of the compression processing portion 9 related to an image signal).

In addition, the operating portion 201 is not limited to a physical button but may be a button constituting a part of the touch panel (a button is displayed on the display screen of the image display portion 14 and pressing of the button is detected when the pointing member detecting portion 202 detects presence of the pointing member on the region where the button is displayed). In addition, the pointing member detecting portion 202 is not limited to the detection film disposed on the display screen of the image display portion 14 but may be an optical sensor disposed on the periphery of the display screen of the image display portion 14.

In addition, the external memory 10 may be any type that can record an image signal and a sound signal. For instance, it is possible to use a semiconductor memory such as a Secure Digital (SD) card, an optical disc such as a DVD, a magnetic disk such as a hard disk, as the external memory 10. In addition, the external memory 10 may be detachable from the image pickup apparatus 1.

<<Output Image Processing Portion>>

Details of structure and action of the above-mentioned output image processing portion 13 are described with reference to the drawings. In addition, for simple description below, an image signal processed by the output image processing portion 13 is referred to as an image. Further, an image signal that is supplied to and is processed in the output image processing portion 13 is referred to as an “input image”, while an image signal that has been processed in and output from the output image processing portion 13 is referred to as an “output image”.

<Auxiliary Image>

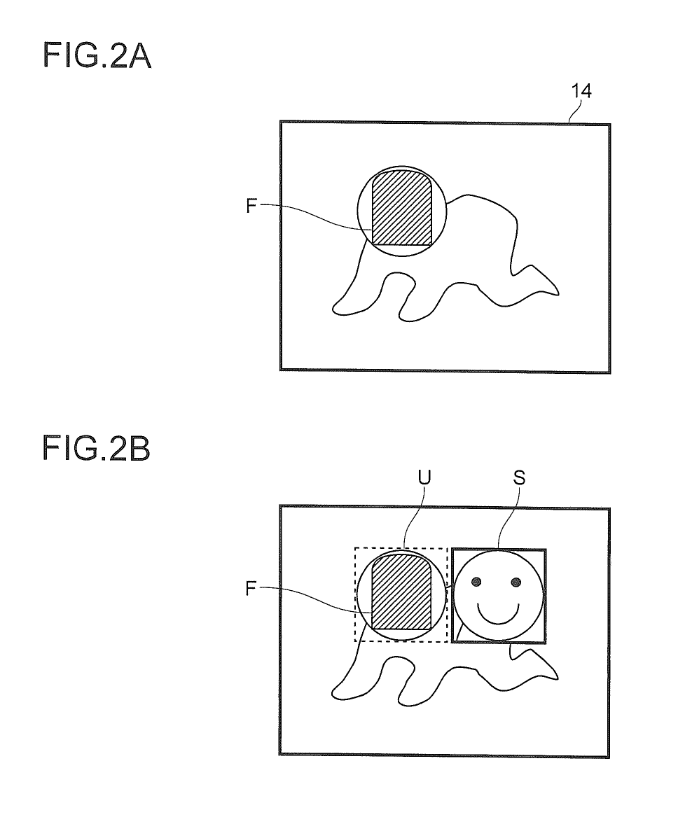

First, the output image that can be generated by the output image processing portion 13 is described with reference to the drawings. Each of FIGS. 2A and 2B is diagram illustrating display screen of the image display portion 14 on which the output image is displayed. In FIGS. 2A and 2B, in order to clearly distinguish a pointing member F existing on the display screen of the image display portion 14 from the output image displayed on the display screen of the image display portion 14, the pointing member F is illustrated with hatching.

As illustrated in FIG. 2A, when the user places the pointing member F on the display screen of the image display portion 14 (when the pointing member detecting portion 202 is operated), it is difficult for the user to view the area of the output image displayed under the pointing member F. Therefore, for example, the user cannot easily grasp whether or not a desired output image is obtained by the operation of the pointing member detecting portion 202, or whether or not an intended position is correctly designated by the pointing member F.

Therefore, as illustrated in FIG. 2B, the output image processing portion 13 of this example generates an output image in which an auxiliary image S including a region in the output image corresponding to a position of the pointing member F detected by the pointing member detecting portion 202 is superposed on a region different from the above-mentioned region in the output image. In the specification and the attached drawings, the words “superpose” and “superposition” have the same meaning as the words “superimpose” and “superimposition”, respectively.

Specifically, as illustrated in FIG. 2B, the output image processing portion 13 generates the auxiliary image S based on an obtained region U including an invisible region displayed under the pointing member F (the region in the image overlapping with the pointing member F in the diagram) when the output image is displayed on the display screen of the image display portion 14, and superposes the auxiliary image S on a region different from the invisible region in the image so that the output image is generated.

With above-mentioned structure, the user can easily view the region displayed under the pointing member in the output image displayed on the display screen of the image display portion 14, thanks to the auxiliary image S. Therefore, usability of the image pickup apparatus 1 can be improved.

Note that the output image processing portion 13 may generate the output image including the auxiliary image S without substantial change in a size of the obtained region U like the output image as illustrated in FIG. 2B, or may generate the output image including the auxiliary image S in which a size of the obtained region U is changed (e.g., enlarged).

In addition, for convenience sake of description, the obtained region U is illustrated in FIG. 2B, but the output image processing portion 13 may generate the output image in which the obtained region U is not indicated or may generate the output image in which the obtained region U is indicated.

<Structural Example of Output Image Processing Portion>

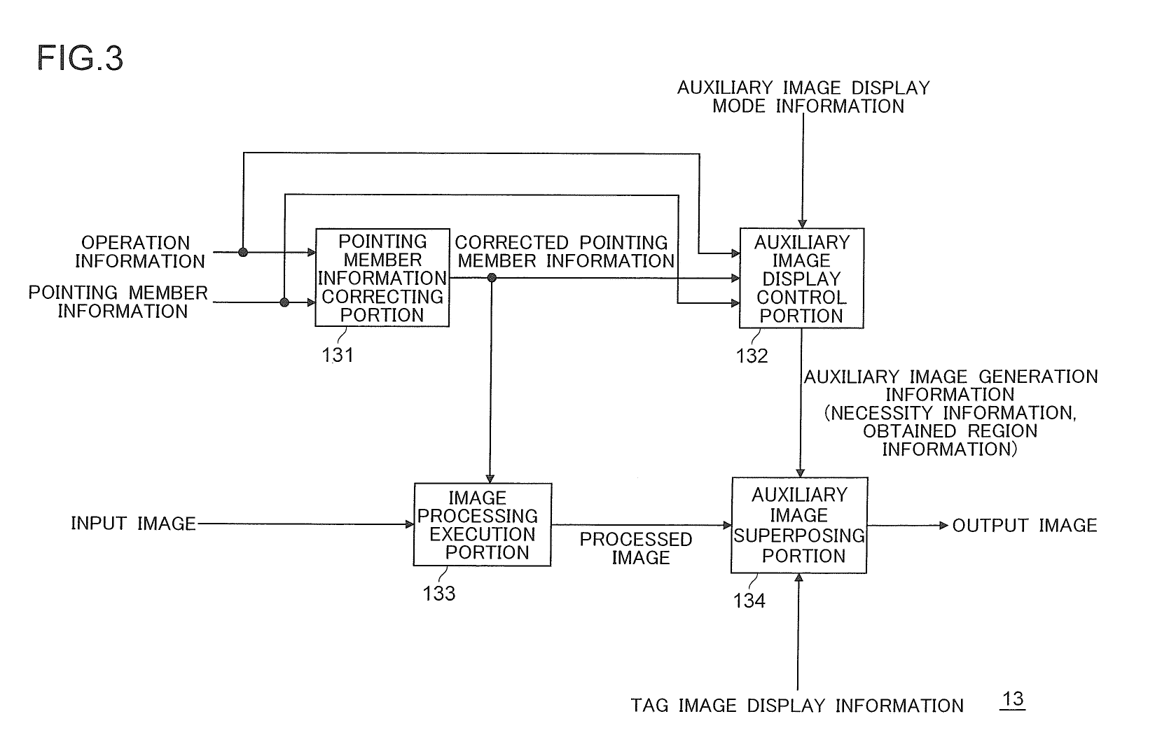

Hereinafter, a structural example and an action example of the output image processing portion 13 that generates the output image including the above-mentioned auxiliary image are described. First, a structural example of the output image processing portion 13 is described with reference to the drawings. FIG. 3 is a block diagram illustrating a structural example of the output image processing portion.

As illustrated in FIG. 3, the output image processing portion 13 includes a pointing member information correcting portion 131 that corrects pointing member information output from the pointing member detecting portion 202 based on an operation information output from the operating portion 201 and generates corrected pointing member information, an auxiliary image display control portion 132 that generates auxiliary image generation information based on the operation information, the pointing member information, the corrected pointing member information, and auxiliary image display mode information, an image processing execution portion 133 that performs a process on the input image based on the corrected pointing member information so as to generate a processed image, and an auxiliary image superposing portion 134 that is capable of generating an output image in which the auxiliary image is superposed on the processed image based on the auxiliary image generation information and tag image display information.

The operation information is information indicating a state of a predetermined button included in the operating portion 201, for example. The operation information has a value corresponding to operation (ON) when the predetermined button is pressed and has a value corresponding to non-operation (OFF) when the predetermined button is not pressed.

The pointing member information is information indicating a position of the pointing member existing on the display screen of the image display portion 14 detected by the pointing member detecting portion 202. The pointing member information can be interpreted to indicate also the invisible regions in the input image and in the processed image. Note that the pointing member information may contain not only a position of the pointing member on the display screen of the image display portion 14 but also an area of the pointing member. In the following description, for simple description, it is supposed that the pointing member information indicates a position and an area of the pointing member on the display screen of the image display portion 14.

The corrected pointing member information is obtained by the pointing member information correcting portion 131 that corrects the pointing member information as necessary to improve usability of the image pickup apparatus 1. In addition, the auxiliary image display mode information indicates a method of determining whether it is necessary or not to generate the output image including the auxiliary image. The auxiliary image display mode information is determined by the user or the manufacturer and is supplied from the CPU 18 or the like.

The auxiliary image generation information is information for the auxiliary image superposing portion 134 to generate the auxiliary image and includes information indicating whether it is necessary or not to generate the output image including the auxiliary image (hereinafter, referred to as necessity information) and information for the auxiliary image superposing portion 134 to set the obtained region in the processed image (hereinafter, referred to as obtained region information).

In addition, the tag image display information indicates whether the image to be added to the output image including the auxiliary image (hereinafter, referred to as a tag image) is necessary or not and a display format thereof. The tag image display information is determined by the user or the manufacturer, for example, and is input from the CPU 18 or the like.

Note that the structural example illustrated in FIG. 3 is merely an example, and any structure may be adopted as long as it can generate the output image including the auxiliary image. For instance, it is possible to adopt a structure without the pointing member information correcting portion 131. In this case, the corrected pointing member information is regarded as the pointing member information. In addition, for example, it is possible that the image processing execution portion 133 is not disposed, or that the image processing execution portion 133 is included in the input image processing portion 5 (it may be a structure in which the processed image can be recorded in the external memory 10). In this case, the processed image is regarded as the input image. In addition, for example, it is possible that the operation information is unnecessary. However, in the following description, for simple description, it is supposed that the image processing portion 13 has a structure illustrated in FIG. 3.

[Pointing Member Information Correcting Portion]

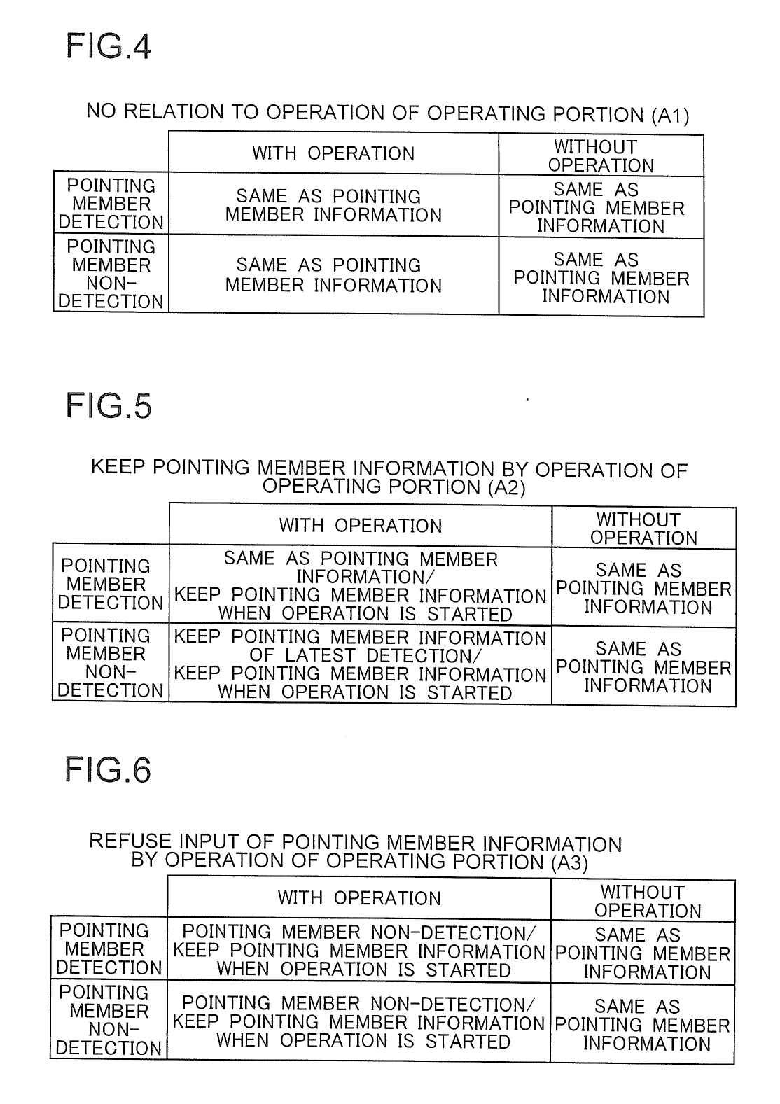

The pointing member information correcting portion 131 corrects the pointing member information as necessary based on the operation information, and outputs the result as the corrected pointing member information. An action example of the pointing member information correcting portion 131 is described with reference to the drawings. FIGS. 4 to 6 are tables showing the action examples (A1 to A3) of the pointing member information correcting portion.

Term “pointing member detection” in FIGS. 4 to 6 means a case where the pointing member detecting portion 202 detects the pointing member existing on the display screen of the image display portion 14, and outputs the detected position and area of the pointing member as the pointing member information. On the other hand, term “pointing member non-detection” means a case where the pointing member detecting portion 202 detects that the pointing member does not exist on the display screen of the image display portion 14, and outputs the result as the pointing member information (or outputs nothing). In addition, term “with operation” means that the user operates the operating portion 201 (e.g., a predetermined button of the operating portion 201 is pressed by the user), and the operating portion 201 outputs the information as the operation information. On the other hand, term “without operation” means a case where the user does not operate the operating portion 201 (e.g., a predetermined button of the operating portion 201 is not pressed by the user), and the operating portion 201 outputs the information as the operation information.

### Action Example: A1

FIG. 4 is a table showing an action example (A1) of the pointing member information correcting portion. In this action example, the pointing member information correcting portion 131 outputs the corrected pointing member information that is not related to the operation information. In other words, the output image processing portion 13 regards pieces of the pointing member information that are input sequentially to be valid.

As illustrated in FIG. 4, in this action example, the pointing member information correcting portion 131 outputs the corrected pointing member information that is the same as the pointing member information regardless of whether or not the operating portion 201 is operated by the user and whether or not the pointing member detecting portion 202 detects the pointing member existing on the display screen of the image display portion 14.

### Action Example: A2

FIG. 5 is a table showing an action example (A2) of the pointing member information correcting portion. In this action example, when the user operates the operating portion 201, the pointing member information correcting portion 131 holds the pointing member information that is being input (or was being input), and outputs the held pointing member information as the corrected pointing member information. In other words, while the operating portion 201 is being operated by the user, the output image processing portion 13 regards pieces of the pointing member information that are obtained sequentially or the pointing member information obtained before the operation of the operating portion 201 is started to be valid.

As illustrated in FIG. 5, in this action example, when the operating portion 201 is not operated by the user, regardless of whether or not the pointing member detecting portion 202 detects the pointing member existing on the display screen of the image display portion 14, the pointing member information correcting portion 131 outputs the corrected pointing member information that is the same as the pointing member information.

On the other hand, when the operating portion 201 is operated by the user, and when the pointing member detecting portion 202 detects the pointing member existing on the display screen of the image display portion 14, the pointing member information correcting portion 131 outputs the corrected pointing member information that is the same as the pointing member information. Alternatively, in this case, the pointing member information correcting portion 131 holds the pointing member information that is input upon start of input of the operation information indicating that there is an operation of the operating portion 201 (that is, upon start of operation of the operating portion 201), and continuously outputs the pointing member information as the corrected pointing member information. Note that the manufacturer may determine which one of the above-mentioned pieces of corrected pointing member information is output from the pointing member information correcting portion 131, when the image pickup apparatus 1 is manufactured, or the user may determine the same when the image pickup apparatus 1 is used.

In addition, when the operating portion 201 is operated by the user and when the pointing member detecting portion 202 detects that the pointing member does not exist on the display screen of the image display portion 14, the pointing member information correcting portion 131 outputs, of pieces of the pointing member information when the pointing member existing on the display screen of the image display portion 14 is detected, the one that is input and held last, as the corrected pointing member information. Alternatively, in this case, the pointing member information correcting portion 131 holds the pointing member information that is input upon start of input of the operation information indicating that there is an operation of the operating portion 201 (that is, upon start of operation of the operating portion 201), and continuously outputs the held pointing member information as the corrected pointing member information. Note that the manufacturer may determine which one of the above-mentioned pieces of corrected pointing member information is output from the pointing member information correcting portion 131, when the image pickup apparatus 1 is manufactured, or the user may determine the same when the image pickup apparatus 1 is used.

With this structure, even when the pointing member does not exist on the display screen of the image display portion 14, the user can operate the operating portion 201 so that the output image processing portion 13 can work regarding that the pointing member exists on the display screen of the image display portion 14 in a simulation manner. Therefore, usability of the image pickup apparatus 1 can be further improved.

Specifically, for example, while the user temporarily removes the pointing member from the display screen of the image display portion 14 so as to view the entire of the displayed output image, when the operating portion 201 is operated, the output image processing portion 13 can work regarding that the pointing member exists on the display screen of the image display portion 14 in a simulation manner (e.g., regarding that the user has not finished the operation of the pointing member detecting portion 202, and that movement of the pointing member is temporarily stopped on the display screen of the image display portion 14).

### Action Example: A3

FIG. 6 is a table showing an action example (A3) of the pointing member information correcting portion. In this action example, when the user operates the operating portion 201, the pointing member information correcting portion 131 refuses the pointing member information that is input later, and outputs the corrected pointing member information regardless of the pointing member information. In other words, when the operating portion 201 is operated by the user, the output image processing portion 13 regards the pointing member information obtained after the start of operation of the operating portion 201 to be invalid.

As illustrated in FIG. 6, in this action example, when the operating portion 201 is not operated by the user, regardless of whether or not the pointing member detecting portion 202 detects the pointing member existing on the display screen of the image display portion 14, the pointing member information correcting portion 131 outputs the corrected pointing member information that is the same as the pointing member information.

On the other hand, when the operating portion 201 is operated by the user, and when the pointing member detecting portion 202 detects the pointing member existing on the display screen of the image display portion 14, the pointing member information correcting portion 131 outputs the corrected pointing member information indicating to detect that the pointing member is not exist on the display screen of the image display portion 14 (or outputs nothing). Alternatively, in this case, the pointing member information correcting portion 131 holds the pointing member information that is input upon start of input of the operation information indicating that there is an operation of the operating portion 201 (that is, upon start of operation of the operating portion 201), and continuously outputs the held pointing member information as the corrected pointing member information. Note that the manufacturer may determine which one of the above-mentioned pieces of corrected pointing member information is output from the pointing member information correcting portion 131, when the image pickup apparatus 1 is manufactured, or the user may determine the same when the image pickup apparatus 1 is used.

In addition, when the operating portion 201 is operated by the user, and when the pointing member detecting portion 202 detects that the pointing member does not exist on display screen of the image display portion 14, the pointing member information correcting portion 131 outputs the corrected pointing member information indicating that the pointing member does not exist on the display screen of the image display portion 14 (or outputs nothing). Alternatively, in this case, the pointing member information correcting portion 131 holds the pointing member information that is input upon start of input of the operation information indicating that there is an operation of the operating portion 201 (that is, upon start of operation of the operating portion 201), and continuously outputs the held pointing member information as the corrected pointing member information. Note that the manufacturer may determine which one of the above-mentioned pieces of corrected pointing member information is output from the pointing member information correcting portion 131, when the image pickup apparatus 1 is manufactured, or the user may determine the same when the image pickup apparatus 1 is used.

With this structure, it is possible that the user operates the operating portion 201 so that the pointing member detecting portion 202 can be disabled. Therefore, usability of the image pickup apparatus 1 can be further improved.

Specifically, for example, suppose the case where, when the user finishes to operate the pointing member detecting portion 202 so as to remove the pointing member from the display screen of the image display portion 14, the pointing member is moved by mistake so that the movement is detected by the pointing member detecting portion 202. In this case, if the user operates the operating portion 201 when the operation of the pointing member detecting portion 202 is finished, the pointing member information indicating the movement can be invalidated.

Note that the above-mentioned action examples A1 to A3 are merely examples, which may be partially changed, or the pointing member information correcting portion 131 may perform an action other than the action examples A1 to A3. In addition, the manufacturer may determine one of the action examples A1 to A3 in which the pointing member information correcting portion 131 works, when the image pickup apparatus 1 is manufactured, or the user may determine the same when the image pickup apparatus 1 is used. In the latter case, similarly to the auxiliary image display control portion 132 that will be described later, information indicating one of the action examples A1 to A3 in which the pointing member information correcting portion 131 works is supplied to the pointing member information correcting portion 131, and the pointing member information correcting portion 131 may work as the action example indicated by the information. Further, the information may be the auxiliary image display mode information. In other words, the pointing member information correcting portion 131 may work together with the auxiliary image display control portion 132.

In addition, the action examples A1 to A3 may be selected appropriately in accordance with an action state of the image pickup apparatus 1. In addition, the action example A2 and the action example A3 may be performed simultaneously. In this case, it is preferable that the operation information (e.g., a button of the operating portion 201) is different between the action examples, and it is preferable that one of action examples is performed with higher priority when both pieces of the operation information are input simultaneously.

[Auxiliary Image Display Control Portion]

The auxiliary image display control portion 132 regards, for example, the pointing member information or the corrected pointing member information as the obtained region information. Then, the auxiliary image display control portion 132 outputs the auxiliary image generation information including the obtained region information.

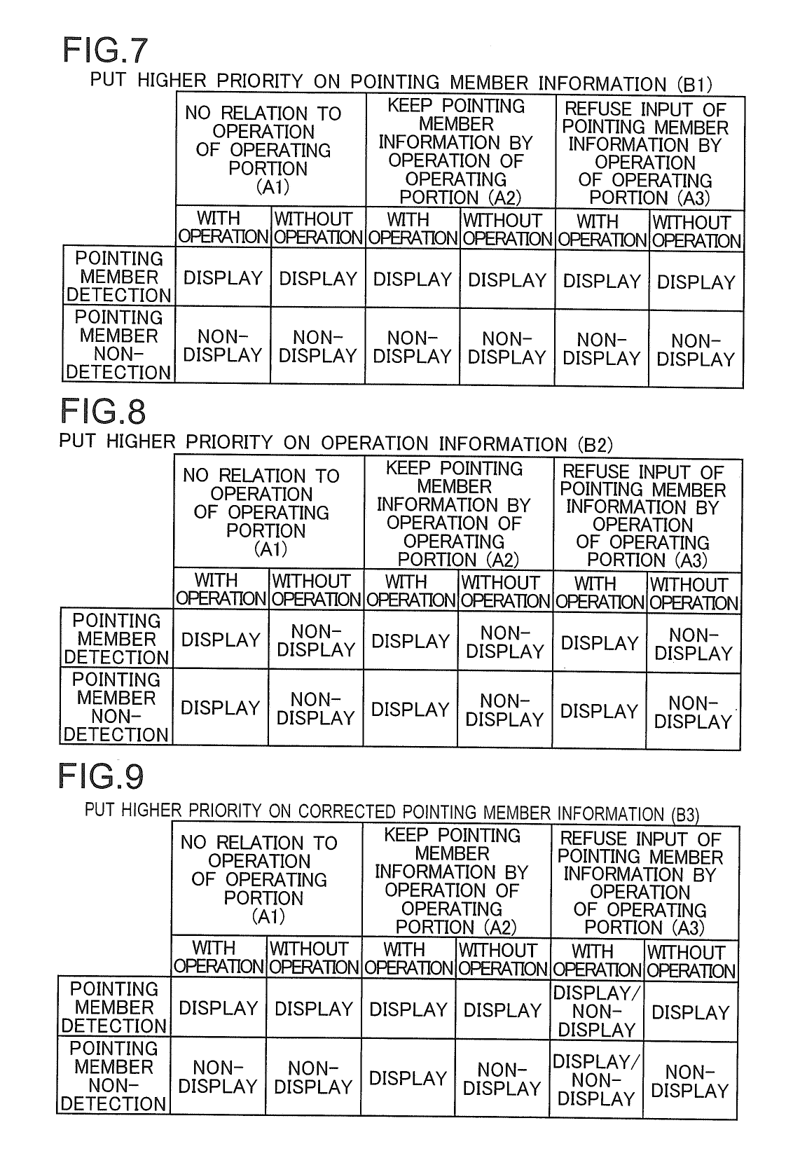

In addition, based on the operation information, the pointing member information, the corrected pointing member information, and the auxiliary image display mode information, the auxiliary image display control portion 132 determines whether it is necessary or not to generate the output image including the auxiliary image. Then, the auxiliary image display control portion 132 outputs the auxiliary image generation information including the necessity information indicating a result of the determination. This action example of the auxiliary image display control portion 132 is described with reference to the drawings. FIGS. 7 to 9 are tables showing action examples (B1 to B3) of the auxiliary image display control portion.

Term “display” in FIGS. 7 to 9 indicates a case where the auxiliary image display control portion 132 determines to display the output image including the auxiliary image on the display screen of the image display portion 14. On the other hand, “non-display” indicates a case where the auxiliary image display control portion 132 determines to display the output image without the auxiliary image on the display screen of the image display portion 14. Note that other terms in FIGS. 7 to 9 are the same as described above with reference to FIGS. 4 to 6, and description thereof is omitted.

### Action Example: B1

FIG. 7 is a table showing an action example (B1) of the auxiliary image display control portion. In this action example, the auxiliary image display control portion 132 determines whether or not to generate the output image including the auxiliary image using the pointing member information with higher priority. In addition, the auxiliary image display mode information indicating this determination method is input to the auxiliary image display control portion 132.

As illustrated in FIG. 7, in this action example, regardless of the action examples A1 to A3 of the pointing member information correcting portion 131 and whether or not the operating portion 201 is operated by the user, when the pointing member detecting portion 202 detects the pointing member existing on the display screen of the image display portion 14, the auxiliary image display control portion 132 determines to generate the output image including the auxiliary image. In addition, when the pointing member detecting portion 202 detects that the pointing member does not exist on display screen of the image display portion 14, the auxiliary image display control portion 132 determines to generate the output image without auxiliary image.

With this structure, when the pointing member actually exists on the display screen of the image display portion 14, the output image including the auxiliary image can be displayed on the display screen of the image display portion 14.

### Action Example: B2

FIG. 8 is a table showing an action example (B2) of the auxiliary image display control portion. In this action example, the auxiliary image display control portion 132 determines whether or not to generate the output image including the auxiliary image using the operation information with higher priority. In addition, the auxiliary image display mode information indicating this determination method is input to the auxiliary image display control portion 132.

As illustrated in FIG. 8, in this action example, regardless of the action examples A1 to A3 of the pointing member information correcting portion 131 and whether or not the pointing member detecting portion 202 detects the pointing member existing on the display screen of the image display portion 14, when the operating portion 201 is operated by the user, the auxiliary image display control portion 132 determines to generate the output image including the auxiliary image. In addition, when the operating portion 201 is not operated by the user, the auxiliary image display control portion 132 determines to generate the output image without auxiliary image.

With this structure, it is possible to display the output image including the auxiliary image on the display screen of the image display portion 14 when the user explicitly requests by operating the operating portion 201.

### Action Example: B3

FIG. 9 is a table showing an action example (B3) of the auxiliary image display control portion. In this action example, the auxiliary image display control portion 132 determines whether or not to generate the output image including the auxiliary image based on the corrected pointing member information (the pointing member information regarded by the output image processing portion 13 to be valid based on the pointing member information and the operation information, see FIGS. 4 to 6) with higher priority. In addition, the auxiliary image display mode information indicating this determination method is input to the auxiliary image display control portion 132.

As illustrated in FIG. 9, in this action example, when the pointing member information correcting portion 131 outputs the corrected pointing member information indicating that the pointing member exists on the display screen of the image display portion 14 (see FIGS. 4 to 6), the auxiliary image display control portion 132 determines to generate the output image including the auxiliary image. In addition, when the pointing member information correcting portion 131 outputs the corrected pointing member information indicating that the pointing member does not exist on the display screen of the image display portion 14 (see FIGS. 4 to 6), the auxiliary image display control portion 132 determines to generate the output image without auxiliary image.

If the pointing member information correcting portion 131 works in the action example A3, and when the operating portion 201 is operated by the user, depending on the manufacturer's determination or on the user's determination, the pointing member information correcting portion 131 outputs the corrected pointing member information indicating that the pointing member exists on the display screen of the image display portion 14 or the corrected pointing member information indicating that the pointing member does not exist on the display screen of the image display portion 14 (see FIG. 6). In this case, too, similarly to the above-mentioned case, based on the corrected pointing member information output by the pointing member information correcting portion 131, the auxiliary image display control portion 132 determines whether or not to generate the output image including the auxiliary image.

With this structure, corresponding to the corrected pointing member information that is generated for improving the usability of the image pickup apparatus 1, it is possible to determine whether or not to display the output image including the auxiliary image on the display screen of the image display portion 14.

Note that the above-mentioned action examples B1 to B3 are merely examples, which can be changed partially, or the auxiliary image display control portion 132 may perform an action other than the action examples B1 to B3. In addition, the manufacturer may determine one of the action examples B1 to B3 in which the auxiliary image display control portion 132 works, when the image pickup apparatus 1 is manufactured, or the user may determine the same when the image pickup apparatus 1 is used. In the former case, it is possible that the auxiliary image display mode information is not input to the auxiliary image display control portion 132.

In addition, the auxiliary image display control portion 132 may determine one of the pointing member information and the corrected pointing member information to be regarded as the obtained region information, based on the auxiliary image display mode information. Specifically, for example, when the auxiliary image display control portion 132 determines whether it is necessary or not to generate the output image including the auxiliary image using the pointing member information with higher priority like the action example B1, the pointing member information may be regarded as the obtained region information. In addition, for example, when the auxiliary image display control portion 132 determines whether it is necessary or not to generate the output image including the auxiliary image using the corrected pointing member information with higher priority like the action example B3, the corrected pointing member information may be regarded as the obtained region information.

[Image Processing Execution Portion]

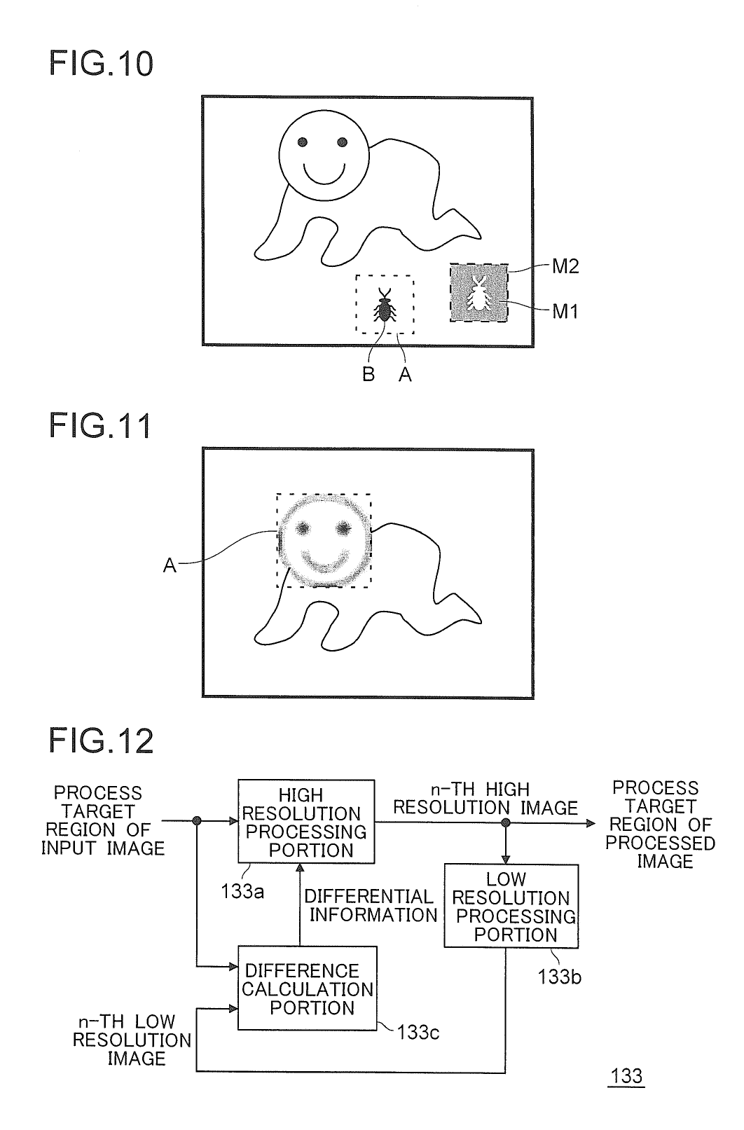

The image processing execution portion 133 performs image processing based on the corrected pointing member information on the input image so as to generate the processed image. This action example of the image processing execution portion 133 is described with reference to the drawings. FIGS. 10 to 13 are diagrams illustrating action examples (C1 to C3) of the image processing execution portion.

### Action Example: C1

FIG. 10 is a diagram illustrating an action example (C1) of the image processing execution portion and illustrates an example of the input image. In this action example, the image processing execution portion 133 performs a process of removing the unnecessary object region B in the input image.

As illustrated in FIG. 10, in this action example, the user first views the output image (input image of FIG. 10) displayed on the display screen of the image display portion 14 and designates the unnecessary object region B by the pointing member. In this case, the pointing member detecting portion 202 detects the position and area of the pointing member on the display screen of the image display portion 14 and inputs the corrected pointing member information indicating the position and area of the unnecessary object region B in the input image to the image processing execution portion 133. The image processing execution portion 133 sets the process target region A including the unnecessary object region B based on this corrected pointing member information.

The image processing execution portion 133 compares an image of the region obtained by removing the unnecessary object region B from the process target region A with an image of the region obtained by removing the process target region A from the input image as image matching or the like, so as to search for a region similar to the region obtained by removing the unnecessary object region B from the process target region A from the region obtained by removing the process target region A from the input image.

As a result of the above-mentioned search, it is supposed that a similar region M1 with hollow inside (the region illustrated in gray color that does not include the inside region illustrated in white color) is searched from the region obtained by removing the process target region A from the input image. In this case, the image processing execution portion 133 mixes the appropriation region M2 as the similar region M1 in which the inside is not hollow (region obtained by combining the region illustrated in gray color and the inside region illustrated in white color) with the region obtained by removing the unnecessary object region B from the process target region A at a predetermined mixing ratio (e.g., as weighted addition). Note that the appropriation region M2 is a region having substantially the same shape and size as the process target region A.

The image processing execution portion 133 performs the above-mentioned process so as to generate the processed image in which the unnecessary object region B is removed. In addition, as described above, when the user operates the pointing member detecting portion 202, the output image including the auxiliary image can be displayed on the display screen of the image display portion 14.

With this structure, the user can obtain the processed image from which the unnecessary object region B is removed only by designating the unnecessary object region B in the output image displayed on the display screen of the image display portion 14 using the pointing member. In addition, when the image processing execution portion 133 performs this process, the output image including the auxiliary image can be displayed on the display screen of the image display portion 14. Therefore, the user can easily grasp whether or not the desired image is obtained.

Note that the process of this action example is performed repeatedly, and it is possible to set the above-mentioned mixing ratio or the like so that the unnecessary object region B is gradually removed by performing the action example repeatedly (e.g., when the user repeatedly rubs the pointing member against the unnecessary object region B in the output image displayed on the display screen of the image display portion 14).

In addition, for convenience sake of description, the process target region A, the unnecessary object region B, the similar region M1 and the appropriation region M2 are illustrated in FIG. 10, but the output image processing portion 13 may generate an output image that does not indicate these regions, or may generate an output image indicating at least one of these regions. In addition, FIG. 10 illustrates the case where the user designates a contour of the unnecessary object region B with high accuracy. However, even if the user designates a position of the unnecessary object region B and its periphery approximately without considering the contour of the unnecessary object region B, it is possible to obtain the processed image without the unnecessary object region B.

In addition, this action example is not limited to the process of removing the unnecessary object region B in the input image but can be applied to various processes of changing a predetermined region in the input image (changing the image itself).

### Action Example: C2

FIGS. 11 and 12 are diagrams illustrating an action example (C2) of the image processing execution portion. FIG. 11 illustrates an example of the processed image, and FIG. 12 is a block diagram illustrating a structure (or a function) of a main portion of the image processing execution portion 133 performing the process of this action example. In this action example, the image processing execution portion 133 performs a process of enhancing sense of resolution of a part region in the input image (i.e., super-resolution processing, for example).

As illustrated in FIG. 11, in this action example, the user first views the output image displayed on the display screen of the image display portion 14 (input image of FIG. 11) and designates the region in which the sense of resolution is to be enhanced, using the pointing member. In this case, the pointing member detecting portion 202 detects the position and area of the pointing member on the display screen of the image display portion 14, and inputs the corrected pointing member information indicating the position and area of the region in which the sense of resolution is to be enhanced in the input image to the image processing execution portion 133. The image processing execution portion 133 sets the process target region A including the region in which the sense of resolution is to be enhanced based on this corrected pointing member information.

In addition, as illustrated in FIG. 12, the image processing execution portion 133 includes a high resolution processing portion 133a that generates a first high resolution image by performing a high resolution process on the process target region A in the input image, or generates an (n+1)th high resolution image by performing a high resolution process on an n-th low resolution image (n denotes a natural number) based on a differential information, a low resolution processing portion 133b that generates an n-th low resolution image by performing a low resolution process on the n-th high resolution image, and a difference calculation portion 133c that calculates a difference between the process target region A in the input image and the n-th low resolution image so as to generate the differential information. In addition, the n-th high resolution image generated by the high resolution processing portion 133a can be the process target region A of the processed image.

In this action example, the high resolution processing portion 133a first increases resolution of (enlarges) the process target region A in the input image. For instance, pixels of a plurality of images are combined, or a predetermined interpolation process is used for one input image so that high resolution is obtained. Thus, the first high resolution image is obtained.

Next, the low resolution processing portion 133b performs the low resolution process on the first high resolution image obtained by the high resolution processing portion 133a to be substantially the same resolution as the process target region A in the input image. For example, a pixel addition process or a thinning process is used for reducing resolution of the image (reducing the image). Thus, the first low resolution image is obtained.

The difference calculation portion 133c determines a difference between the process target region A in the input image and the first low resolution image, and outputs the result as the differential information. The high resolution processing portion 133a corrects the content of the high resolution process based on the differential information so as to obtain a second high resolution image in which resolution of the input image is increased more accurately. In addition, a third high resolution image is obtained by performing the same process as the above-mentioned process on the second high resolution image. In other words, the same process as the above-mentioned process is performed on the n-th high resolution image so that the (n+1)th high resolution image is obtained.

The above-mentioned series of processes of high resolution and low resolution is performed until being settled (e.g., for a predetermined number of repeating times, or until the difference becomes smaller than a predetermined threshold value), and the n-th high resolution image when being settled is regarded as the process target region A of the processed image.

Then, the image processing execution portion 133 combines the process target region A of the obtained processed image with the region other than the process target region A in the input image so that the processed image is generated. In addition, as described above, when the user operates the pointing member detecting portion 202, the output image including the auxiliary image can be displayed on the display screen of the image display portion 14.

With this structure, the user can obtain the processed image in which the sense of resolution of a region is enhanced only by designating the region in which the sense of resolution is to be enhanced in the output image displayed on the display screen of the image display portion 14, using the pointing member. In addition, when the image processing execution portion 133 performs this process, the output image including the auxiliary image can be displayed on the display screen of the image display portion 14. Therefore, the user can easily grasp whether or not a desired image is obtained.

Note that it is possible to set the above-mentioned settling condition (e.g., the number of repetition or the threshold value of the difference) so that the sense of resolution is gradually enhanced when the process of this action example is performed repeatedly (e.g., when the user repeatedly rubs the pointing member against the region in which the sense of resolution is to be enhanced in the output image displayed on the display screen of the image display portion 14). In addition, for convenience sake of description, the process target region A is illustrated in FIG. 11, but the output image processing portion 13 may generate the output image that does not express the process target region A, or may generate the output image expressing the process target region A.

In addition, it is possible to perform, for example, a simple interpolation process (in which sense of resolution is not enhanced) on a region other than the process target region A in the input image so that the process target region A in the processed image has substantially the same resolution as that in the region other than the process target region A in the processed image, and hence the resolution is enhanced (increased).

In addition, this action example can be used not only in the process of enhancing sense of resolution but also in various processes of adjusting image quality of a predetermined region in the input image.

### Action Example: C3

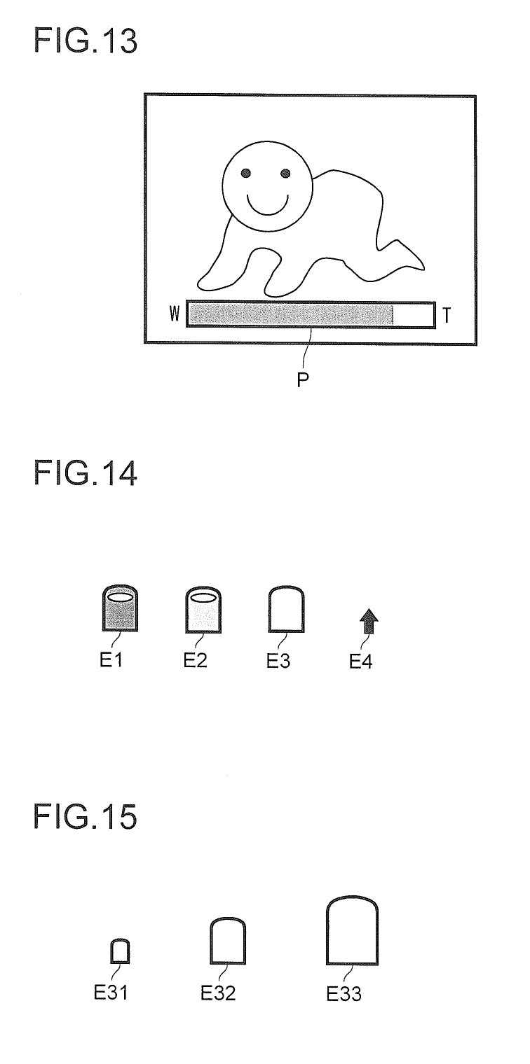

FIG. 13 is a diagram illustrating an action example (C3) of the image processing execution portion, and illustrates an example of the processed image. In this action example, the image processing execution portion 133 performs a process of superposing a bar P on the input image, and the bar P is an image for the user to perform zooming of the image pickup apparatus 1. Note that concerning this bar P, if a value indicating end (end portion indicating a zoom state, which is right end portion in FIG. 13) of the inner gage (region illustrated in gray color) goes to the left side (wide end), zoom out is performed. If the same goes to the right side (telephoto end), zoom in is performed.

As illustrated in FIG. 13, in this action example, the user first views the output image displayed on the display screen of the image display portion 14 (the processed image of FIG. 13), and designates an arbitrary position in the region where the bar P is displayed using the pointing member so as to set a desired state of the gage in the bar P. For example, the user places the pointing member on the display of the value indicating end of the gage in the bar P and slides the pointing member to the left or the right along the bar P so as to set the gage in a desired state.

In this case, the pointing member detecting portion 202 detects the position and area of the pointing member on the display screen of the image display portion 14 and inputs the same as the corrected pointing member information to the image processing execution portion 133. The image processing execution portion 133 superposes the bar P corresponding to this corrected pointing member information in the input image. For example, the bar P in which a position designated by the pointing member becomes the value indicating end of the gage is superposed on the input image.

The image processing execution portion 133 performs the above-mentioned process so as to generate the processed image on which the bar P is superposed. In addition, as described above, when the user operates the pointing member detecting portion 202, the output image including the auxiliary image can be displayed on the display screen of the image display portion 14.

Further, the CPU 18 controls action of the image pickup apparatus 1 so that zoom action corresponding to the above-mentioned user's operation is performed. For example, the position of the zoom lens of the lens portion 3 is moved along the optical axis (optical zoom is performed). In addition, for example, the input image processing portion 5 changes a region (angle of view) to be obtained for generating the input image from the image obtained by imaging (performs electronic zoom).

With this structure, the user can operate zoom of the image pickup apparatus 1 only by operating the gage of the bar P in the output image displayed on the display screen of the image display portion 14, using the pointing member. In addition, when the image processing execution portion 133 performs this operation, the output image including the auxiliary image can be displayed on the display screen of the image display portion 14. Therefore, the user can easily grasp whether or not the intended position is designated correctly by the pointing member.

Note that in FIG. 13, the bar P to be superposed on the input image is illustrated as being used for operating the zoom of the image pickup apparatus 1, but it may be used for other purpose. For example, the bar P to be superposed on the input image may be used for adjusting hue or luminance of the input image or the processed image, or may be used for adjusting directivity of the sound collecting portion 6 or volume of the sound signal to be reproduced by the sound reproducing portion 16.

In addition, this action example can be applied not only to the process of superposing the bar on the input image but also to a process of superposing images for the user to operate various actions of the image pickup apparatus 1 on the input image.

[Auxiliary Image Superposing Portion]

The auxiliary image superposing portion 134 checks, based on the necessity information contained in the auxiliary image generation information, whether it is necessary or not to generate the output image including the auxiliary image. If the auxiliary image superposing portion 134 confirms not to generate the output image including the auxiliary image, the processed image is output as the output image. On the other hand, if the auxiliary image superposing portion 134 confirms to generate the output image containing the processed image, the auxiliary image superposing portion 134 sets the obtained region in the processed image based on the obtained region information contained in the auxiliary image generation information, so as to generate a corrected image.

The auxiliary image superposing portion 134 recognizes the invisible region in the processed image based on the obtained region information (the pointing member information or the corrected pointing member information), and sets the obtained region. For example, the auxiliary image superposing portion 134 sets the region including the invisible region as the obtained region. Note that when the invisible region changes, the auxiliary image superposing portion 134 may change the obtained region corresponding to the change of the invisible region or may keep the obtained region set based on the invisible region that is first set. In addition, it is possible to determine one of the above-mentioned two setting methods of the obtained region to be adopted corresponding to the image processing performed by the image processing execution portion 133. For example, if the image processing execution portion 133 works in the action example C1 (if it is assumed that the user will move the pointing member in a wide range and in an indefinite region on the display screen of the image display portion 14), the auxiliary image superposing portion 134 may adopts the former method of setting the obtained region. If the image processing execution portion 133 works in the action example C2 or C3 (if it is assumed that the user will move the pointing member in a narrow range or in a definite region on the display screen of the image display portion 14), the auxiliary image superposing portion 134 may adopts the latter method of setting the obtained region.

The auxiliary image superposing portion 134 generates the auxiliary image indicating the obtained region set as described above and superposes the same on the processed image. For example, the auxiliary image superposing portion 134 regards the region on which the auxiliary image in the processed image is superposed as the region that neighbors to the obtained region and is included in the processed image. Note that when the auxiliary image superposing portion 134 sets the region on which the auxiliary image in the processed image is superposed, it is possible to set the region based on the obtained region to be as close as possible to the center of the processed image, or to set the region to be as close as possible to the opposite side to user's dominant arm set in advance by the user (e.g., right side if the user is left-handed).

In addition, the auxiliary image superposing portion 134 adds the tag image to the output image including the auxiliary image as necessary based on the tag image display information. This action example is described with reference to the drawings. FIGS. 14 and 15 are diagrams illustrating action examples (D1 and D2) of the auxiliary image superposing portion.

### Action Example: D1

FIG. 14 is a diagram illustrating the action example (D1) of the image processing execution portion, and illustrates an example of the tag image that can be added to the output image including the auxiliary image. The tag images E1 to E4 illustrated in FIG. 14 indicates a position of the pointing member in the obtained region, which is indicated in the auxiliary image.

The tag images E1 to E3 are simulation of the pointing member (e.g., a finger of a human), and a position of the pointing member in the obtained region is illustrated by the region of the tag image E1 to E3 in the auxiliary image. In addition, the tag image E1 is substantially opaque, the tag image E2 is translucent, and the tag image E3 is transparent (only the contour line is viewed).

The tag image E4 is an arrow, which indicates the position of the pointing member in the obtained region by the tip of the arrow of the tag image E4 in the auxiliary image. In addition, the tag image E4 is opaque, but may be translucent similarly to the tag image E2 or may be transparent similarly to the tag image E3.

With this structure, the user can easily grasp a relationship between the region displayed under the pointing member in the output image displayed on the display screen of the image display portion 14 and the position of the pointing member.

### Action Example: D2

FIG. 15 is a diagram illustrating an action example (D2) of the image processing execution portion, and illustrates an example of the tag image that can be added to the output image including the auxiliary image. Note that the tag images E31 to E33 illustrated in FIG. 15 are obtained by applying this action example to the tag image E3 illustrated in FIG. 14. Note that this action example can be applied also to other tag image without limiting to the tag image E3 illustrated in FIG. 14.

Each of the tag images E31 to E33 indicates the position and area of the pointing member in the obtained region by each region of the tag images E31 to E33 in the auxiliary image. As the area of the pointing member becomes larger, the region of each of the tag images E31 to E33 becomes larger.

With this structure, the user can easily grasp a relationship between the region displayed under the pointing member in the output image displayed on the display screen of the image display portion 14 and the position and area of the pointing member.

### Action Example: D3

In this action example, the tag image is not added to the output image including the auxiliary image. In this action example, it is possible to obtain the output image as illustrated in FIG. 2B, for example.

With this structure, the user can clearly grasp the region displayed under the pointing member in the output image displayed on the display screen of the image display portion 14.

<Action Example of Output Image Processing Portion>

The action examples of the individual portions constituting the output image processing portion 13 are described above. Hereinafter, a series of actions is described, in which the action examples are combined. Note that the combination of the action examples of the individual portions in each action in the following description is merely an example, and the action examples of the individual portions described above can be combined in any manner as long as no contradiction arises.

### First Action Example

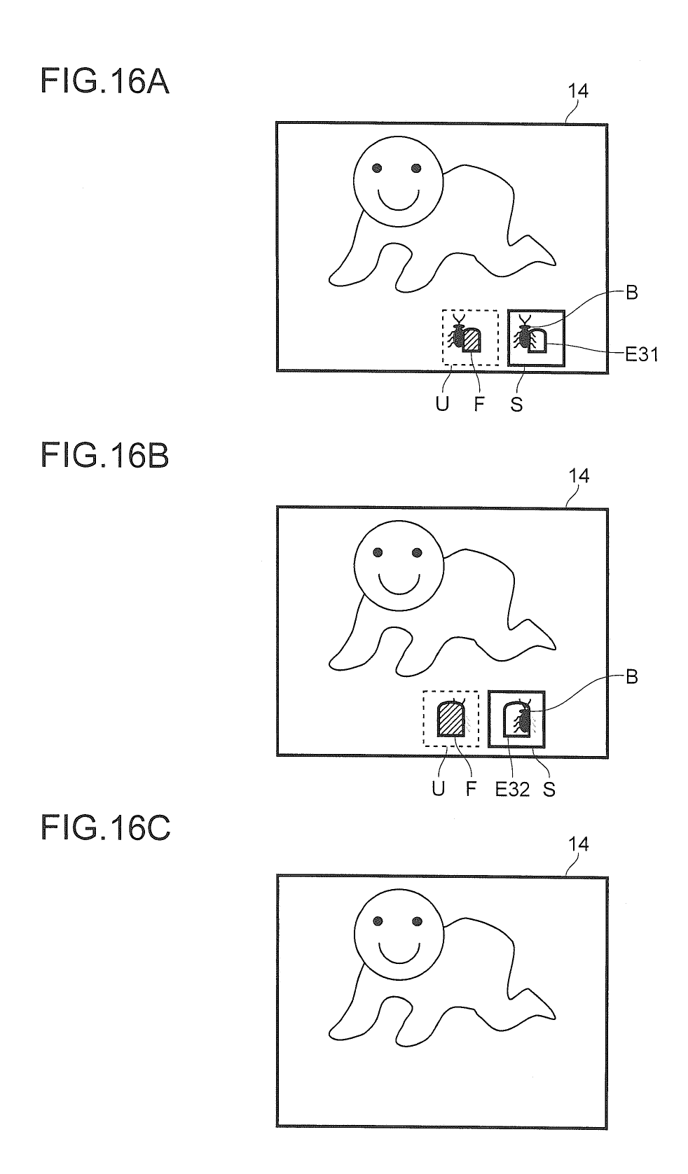

A first action example of the output image processing portion 13 is described with reference to FIGS. 16A to 16C. FIGS. 16A to 16C are diagrams illustrating the first action example of the output image processing portion, and illustrate the display screen of the image display portion 14 on which the output image is displayed. In addition, in FIGS. 16A to 16C, in order to distinguish the output image displayed on the display screen of the image display portion 14 from the pointing member F existing on the display screen of the image display portion 14, the pointing member F is illustrated with hatching. Note that the output images displayed on the display screen of the image display portion 14 as illustrated in FIGS. 16A to 16C are obtained from the input image illustrated in FIG. 10. In addition, it is illustrated that the state of the display screen of the image display portion 14 is changed in order of FIGS. 16A, 16B, and 16C.

The first action example is a case where the pointing member information correcting portion 131 works in the action example A1, the auxiliary image display control portion 132 works in the action example B1, the image processing execution portion 133 works in the action example C1, and the auxiliary image superposing portion 134 works in the action examples D1 and D2 (see the tag image E3 of FIG. 14 and the tag images E31 to E33 of FIG. 15).

First, the input image illustrated in FIG. 10 is displayed as the output image on the display screen of the image display portion 14. Then, when the user designates the unnecessary object region B by the pointing member F, the display screen of the image display portion 14 becomes the state illustrated in FIG. 16A. In the state illustrated in FIG. 16A, the area of the pointing member F on the display screen of the image display portion 14 is small, and therefore the region of the tag image E31 is small.

The user views the state of FIG. 16A and tries to increase the area of the pointing member F as illustrated in FIG. 16B so as to remove the unnecessary object region B more efficiently. In this case, the region of a tag image E32 is enlarged corresponding to increase of the area of the pointing member F on the display screen of the image display portion 14. Further, the user grasps the part where the unnecessary object region B is not removed sufficiently by viewing the auxiliary image S in the output image displayed on the display screen of the image display portion 14 and designates the part with higher priority by the pointing member F.

Then, the user views the auxiliary image S in the output image displayed on the display screen of the image display portion 14 so as to confirm that a desired state is obtained, and removes the pointing member F from the display screen of the image display portion 14. Then, as illustrated in FIG. 16C, the output image without the auxiliary image S (i.e., the processed image) is generated by the auxiliary image superposing portion 134 and is displayed on the display screen of the image display portion 14.

In this way, the user can optimize the operation of the pointing member detecting portion 202 in accordance with the situation by viewing the auxiliary image S in the output image displayed on the display screen of the image display portion 14.

In addition, for convenience sake of description, the obtained region U is illustrated in FIGS. 16A and 16B, but the output image processing portion 13 may generate the output image that does not indicate the obtained region U or may generate the output image indicating the obtained region U.

### Second Action Example

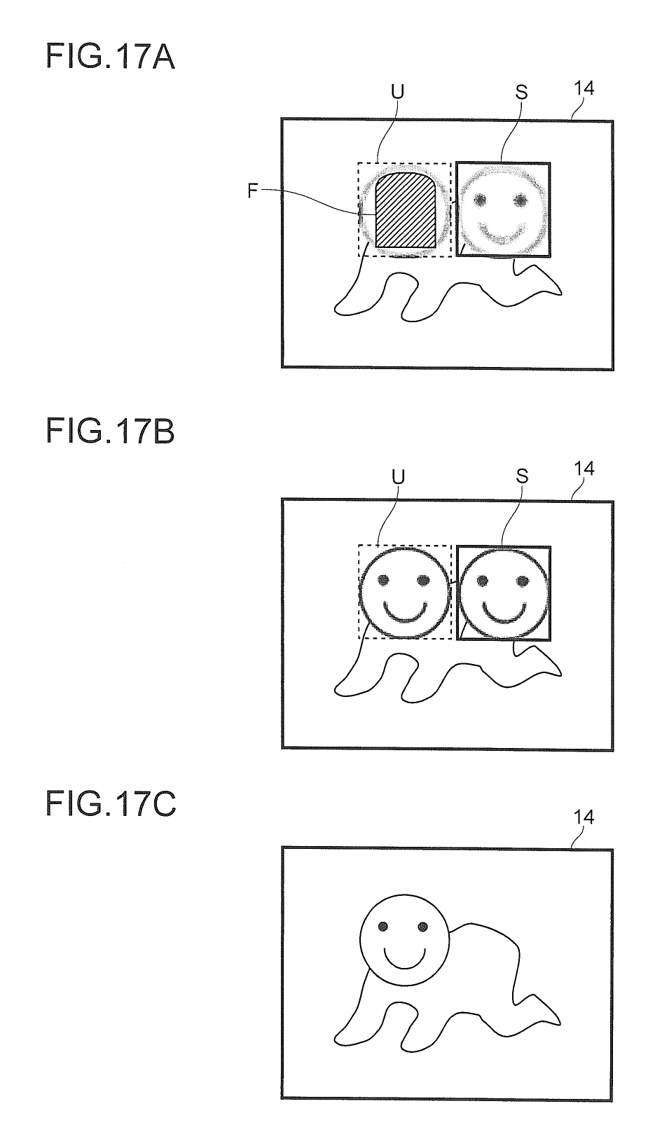

A second action example of the output image processing portion 13 is described with reference to FIGS. 17A to 17C. FIGS. 17A to 17C are diagrams illustrating the second action example of the output image processing portion and illustrate the display screen of the image display portion 14 on which the output image is displayed. In addition, in FIGS. 17A to 17C, in order to clearly distinguish the output image displayed on the display screen of the image display portion 14 from the pointing member F existing on the display screen of the image display portion 14, the pointing member F is illustrated with hatching. Note that the output images displayed on the display screen of the image display portion 14 as illustrated in FIGS. 17A to 17C are obtained from the input image illustrated in FIG. 11. In addition, it is illustrated that the state of the display screen of the image display portion 14 is changed in order of FIGS. 17A, 17B and 17C.

The second action example is a case where the pointing member information correcting portion 131 works in the action example A2, the auxiliary image display control portion 132 works in the action example B2, the image processing execution portion 133 works in the action example C2, and the auxiliary image superposing portion 134 works in the action example D3.

First, the input image illustrated in FIG. 11 is displayed as the output image on the display screen of the image display portion 14. Then, when the user designates the region in which the sense of resolution is to be enhanced by the pointing member F, the display screen of the image display portion 14 becomes the state illustrated in FIG. 17A. The user views the state of FIG. 17A and operates the pointing member detecting portion 202 using the pointing member F so that the process of enhancing sense of resolution is performed repeatedly, while viewing the auxiliary image S in the output image displayed on the display screen of the image display portion 14. Specifically, for example, the user repeatedly rubs the pointing member F against the region in which the sense of resolution is to be enhanced in the output image displayed on the display screen of the image display portion 14.

In addition, the user operates the operating portion 201 (e.g., presses the button) and temporarily removes the pointing member F from the display screen of the image display portion 14, so as to view the entire of the output image displayed on the image display portion 14. In this case, the image processing execution portion 133 recognizes that the user temporarily stopped the movement of the pointing member F on the display screen of the image display portion 14 so as not to finish the image processing but waits for that the user restarts to operate the pointing member detecting portion 202. In addition, in this case, as illustrated in FIG. 17B, the auxiliary image superposing portion 134 generates the output image including the auxiliary image S even when the pointing member F does not exists on the display screen of the image display portion 14.

Then, the user further operates the pointing member detecting portion 202 using the pointing member F and views the auxiliary image S in the output image displayed on the display screen of the image display portion 14 so as to check that a desired state is obtained. Then, the user removes the pointing member F from the display screen of the image display portion 14 without operating the operating portion 201. Then, as illustrated in FIG. 17C, the output image without the auxiliary image S (i.e., the processed image) is generated in the auxiliary image generation portion 134 and is displayed on the display screen of the image display portion 14.

In this way, the user can optimize the operation of the pointing member detecting portion 202 using the pointing member F in accordance with the situation by viewing the auxiliary image S in the output image displayed on the display screen of the image display portion 14. In addition, by operating the operating portion 201 appropriately, the pointing member F can be temporarily removed from the display screen of the image display portion 14 while the image processing execution portion 133 performs the series of image processing.

In addition, for convenience sake of description, the obtained region U is illustrated in FIGS. 17A and 17B, but the output image processing portion 13 may generate the output image in which the obtained region U is not indicated or may generate the output image indicating the obtained region U.

### Third Action Example

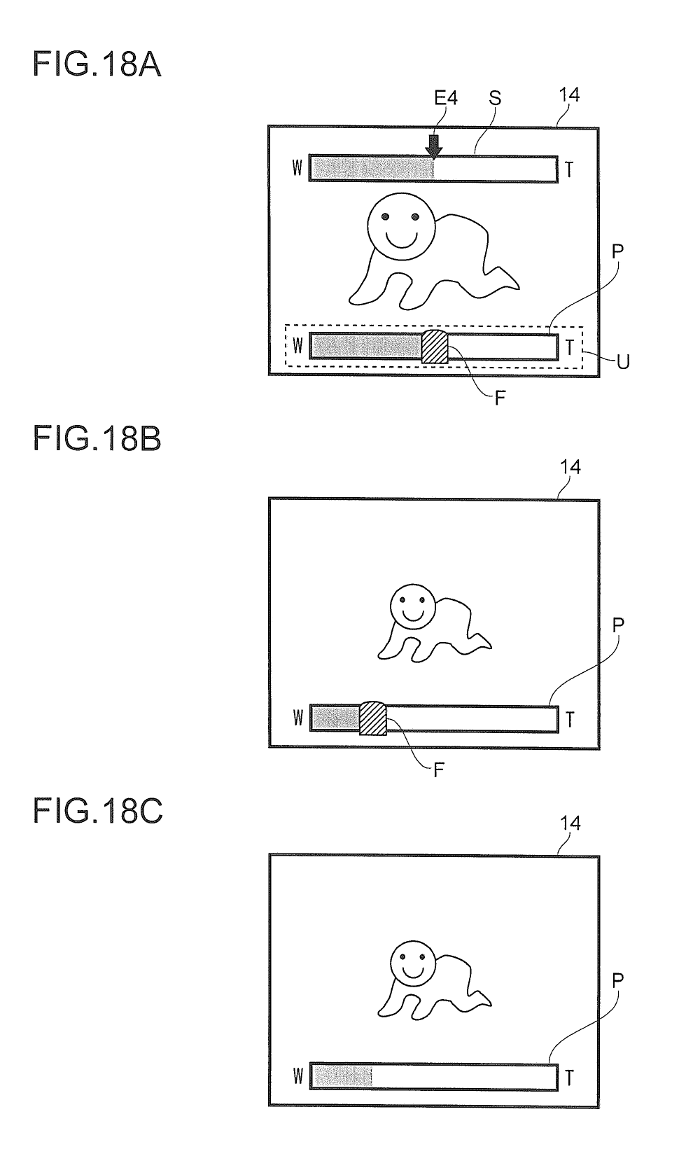

A third action example of the output image processing portion 13 is described with reference to FIGS. 18A to 18C. FIGS. 18A to 18C are diagrams illustrating the third action example of the output image processing portion and illustrate the display screen of the image display portion 14 on which the output image is displayed. In addition, in FIGS. 18A to 18C, in order to clearly distinguish the output image displayed on the display screen of the image display portion 14 from the pointing member F existing on the display screen of the image display portion 14, the pointing member F is illustrated with hatching. Note that FIGS. 18A to 18C illustrate that the state of the display screen of the image display portion 14 is changed in order of FIGS. 18A, 18B and 18C from the state illustrated in FIG. 13 in which the processed image is displayed as the output image on the display screen of the image display portion 14.

The third action example is a case where the pointing member information correcting portion 131 works in the action example A3, the auxiliary image display control portion 132 works in the action example B3, the image processing execution portion 133 works in the action example C3, and the auxiliary image superposing portion 134 works in the action example D1 (see the tag image E4 illustrated in FIG. 14).

First, the input image illustrated in FIG. 13 is displayed as the output image on the display screen of the image display portion 14. Then, the user designates a desired position in the bar P by the pointing member F (e.g., the pointing member F is placed on the display of the value indicating end of the gage in the bar P, and pointing member F is moved to slide along the bar P to a desired position). Then, the display screen of the image display portion 14 becomes the state illustrated in FIG. 18A.

FIG. 18A illustrates a manner in which zoom out is performed by the above-mentioned user's operation from the state obtaining the processed image of FIG. 13, and the output image generated by the output image processing portion 13 based on the newly obtained input image is displayed on the display screen of the image display portion 14. As illustrated in FIG. 18A, in this action example, the tip of the arrow of the tag image E4 indicates the value indicating end in the auxiliary image S (the position of the pointing member F in the obtained region U).

The user views the state of FIG. 18A and operates the pointing member detecting portion 202 using the pointing member F so that zoom out is further performed. Specifically, for example, the user slides the pointing member F further to the left along the bar P.

In addition, the user views the auxiliary image S in the output image displayed on the display screen of the image display portion 14, confirms that a desired zoom (zoom out in the example illustrated in FIGS. 18A and 18B) has been performed, and then operates the operating portion 201. In this action example, when the user operates the operating portion 201, the image processing execution portion 133 and the CPU 18 which controls the zoom action recognize that the pointing member F is removed from the display screen of the image display portion 14. Then, as long as the user is operating the operating portion 201 (e.g., as long as the button is being pressed), the image processing execution portion 133 and the CPU 18 keeps this recognition even when the pointing member F moves on the display screen of the image display portion 14. In addition, in this case, as illustrated in FIG. 18B, the auxiliary image superposing portion 134 generates the output image without the auxiliary image S even when the pointing member F exists on the display screen of the image display portion 14.

Then, the user removes the pointing member F from the display screen of the image display portion 14 and stops operation of the operating portion 201. During this period, as illustrated in FIG. 18C, the output image without the auxiliary image S (i.e., the processed image) is generated by the auxiliary image superposing portion 134 and is displayed on the display screen of the image display portion 14.

In this way, the user can optimize operation of the pointing member detecting portion 202 using the pointing member F in accordance with the situation by viewing the auxiliary image S in the output image displayed on the display screen of the image display portion 14. In addition, by operating the operating portion 201 appropriately, it is possible to invalidate a misoperation of the pointing member F by the user.

In addition, for convenience sake of description, the obtained region U is illustrated in FIG. 18A, but the output image processing portion 13 may generate the output image in which the obtained region U is not indicated or may generate the output image indicating the obtained region U.

<Relationship of Output Image, Auxiliary Image, etc>

As understood from the above-mentioned description, the output images that can be generated in the output image processing portion 13 can be roughly classified into, for example, a first output image on which the auxiliary image S is not superposed (i.e., output image without the auxiliary image S), a second output image on which the auxiliary image S is superposed (i.e., output image including the auxiliary image S), and a third output image on which the auxiliary image S is superposed and to which the tag image is added (i.e., output image including the auxiliary image S and the tag image).

Any one of the first to third output images is generated based on the input image or the processed image (see FIG. 3). Hereinafter, for convenience sake, the input image or the processed image is referred to as a reference image. In addition, the image displayed on the display screen of the image display portion 14 is referred to as a display image. The display image is an image based on the reference image. The display image can be the reference image (the input image or the processed image), or can be the output image (the first, second or third output image).

In addition, the output image on which the auxiliary image S is superposed (i.e., second or third output image) is referred to as a superposition image for convenience sake. The image illustrated in FIG. 2B is an example of the superposition image. In the superposition image generated as the third output image (see FIG. 16A, etc.), the tag image indicating a detected position of the pointing member F (e.g., E31 of FIG. 16A) is indicated in the auxiliary image included in the superposition image (e.g., S of FIG. 16A). In addition, a position of the pointing member F existing on the display screen of the image display portion 14 detected by the pointing member detecting portion 202 is referred to as a detected position of the pointing member F or simply as a detected position. In addition, the display screen of the image display portion 14 is referred to also as a display screen simply.

Using these terms, the technique described above can be expressed as follows.

When the pointing member is detected (i.e., when the pointing member detecting portion 202 detects the pointing member existing on the display screen), as illustrated in FIG. 2B, the output image processing portion 13 can perform a process of setting the obtained region U including the invisible region displayed under the pointing member F based on the detected position of the pointing member F when the display image (output image) is displayed on the display screen, a process of generating the auxiliary image S based on the image signal in the obtained region U of the reference image, a process of setting the region for superposition different from the invisible region (or the obtained region U), and a process of generating the superposition image by superposing the auxiliary image on the region for superposition of the reference image. The invisible region or the obtained region U is a specific region including the detected position of the pointing member F. The output image processing portion 13 can generate any superposition image as the output image and the display image (the same is true in the fourth to sixth action examples described later). The auxiliary image S generated based on the image signal in the obtained region U of the reference image may be the image itself in the obtained region U of the reference image or may be an image obtained by enlarging or reducing the image in the obtained region U of the reference image.

<Other Action Examples of Output Image Processing Portion>

Other action examples of the output image processing portion 13 are described. Note that any obtained region with the initial U (obtained region U₄₁₀ described later and the like) is one type of the obtained region U, while any auxiliary image with the initial S (auxiliary image S₄₁₀ described above and the like) is one type of the auxiliary image S.

### Fourth Action Example

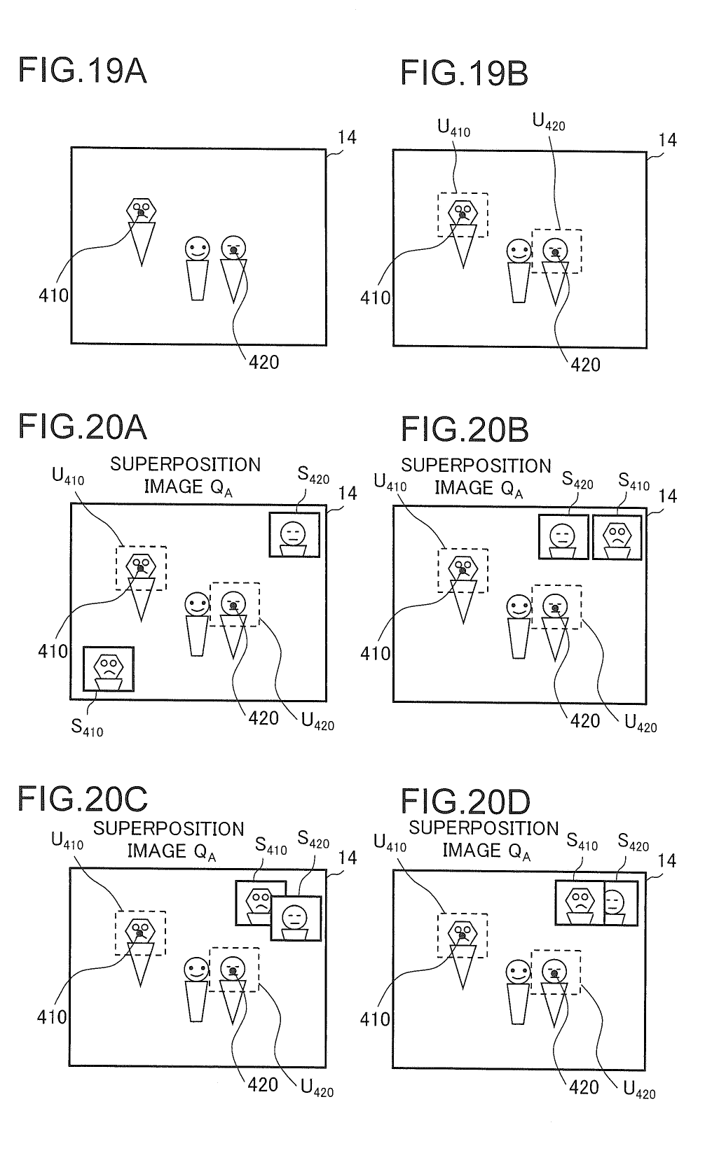

With reference to FIG. 19A and the like, a fourth action example of the output image processing portion 13 is described. FIG. 19A illustrates a manner in which the first output image without the auxiliary image S (i.e., the reference image) is displayed as the display image on the image display portion 14. In the fourth action example of the output image processing portion 13, it is supposed that when the display image based on the input image is displayed on the display screen, the user puts the pointing member on (or close to) a plurality of positions 410 and 420 on the display screen sequentially or simultaneously. As a result, in the pointing member detecting portion 202, the positions 410 and 420 are obtained as a plurality of detected positions (a plurality of detected positions of the pointing member F).

When the plurality of detected positions 410 and 420 are obtained, the output image processing portion 13 sets an obtained region U₄₁₀ including the detected position 410 and an obtained region U₄₂₀ including the detected position 420 (see FIG. 19B) in accordance with the above-mentioned setting method of the obtained region U, and further extracts (generates) an auxiliary image S₄₁₀ corresponding to the obtained region U₄₁₀ and an auxiliary image S₄₂₀ corresponding to the obtained region U₄₂₀ from the reference image (see FIG. 20A, etc.). The auxiliary image S₄₁₀ is the image itself in the obtained region U₄₁₀ of the reference image or an image obtained by enlarging or reducing the image. The same is true for the auxiliary image S₄₂₀.

The output image processing portion 13 sets a first region for superposition different from the obtained region U₄₁₀ (or the invisible region corresponding to the detected position 410) and a second region for superposition different from the obtained region U₄₂₀ (or the invisible region corresponding to the detected position 420), and superposes the auxiliary images S₄₁₀ and S₄₂₀ on the first and second regions for superposition in the reference image, respectively, so that a superposition image Q_{A} is generated.

FIGS. 20A to 20D illustrate a manner of the image display portion 14 displaying an example of the superposition image Q_{A}. As illustrated in FIGS. 20A and 20B, the first and second regions for superposition may be set so that the auxiliary images S₄₁₀ and S₄₂₀ are not overlapped with each other in the superposition image Q_{A}. Alternatively, as illustrated in FIGS. 20C and 20D, the first and second regions for superposition may be set so that the auxiliary images S₄₁₀ and S₄₂₀ are partially overlapped with each other in the superposition image Q_{A}.

In this case, it is arbitrary whether or not a positional relationship between the auxiliary images S₄₁₀ and S₄₂₀ in the superposition image Q_{A} is adjusted to be the same as a positional relationship between the detected positions 410 and 420. For example, if it is adjusted so that the positional relationships becomes the same, and if the detected position 410 exists on the left side of the detected position 420 on the display screen, the auxiliary image S₄₁₀ is disposed on the left side of the auxiliary image S₄₂₀ in the superposition image Q_{A}. In the superposition image Q_{A}, the auxiliary images S₄₁₀ and S₄₂₀ may be aligned in the vertical or horizontal direction, or may not be aligned. In addition, a positional relationship between the auxiliary images S₄₁₀ and S₄₂₀ in the superposition image Q_{A} may be determined based on a temporal relationship between the contact timing of the pointing member with the position 410 and the contact timing of the pointing member with the position 420. For example, the auxiliary image of the detected position corresponding to the earlier contact timing may be disposed on the left side (or on the right side) of the other auxiliary image in the superposition image Q_{A}. In the case where the auxiliary images S₄₁₀ and S₄₂₀ are partially overlapped with each other on the superposition image Q_{A}, the auxiliary image of the detected position corresponding to the later contact timing may be disposed on the other auxiliary image, or in the opposite manner.

Note that it is possible to perform a display such that the user can view a relationship between the detected position and the auxiliary image. For example, the detected positions 410 and 420 may be displayed in first and second colors, respectively on the display screen so that the user can distinguish between the detected positions 410 and 420, while the frames of the auxiliary images 410 and 420 on the display screen may be displayed in the first and second colors (the first and second colors are different from each other), respectively.

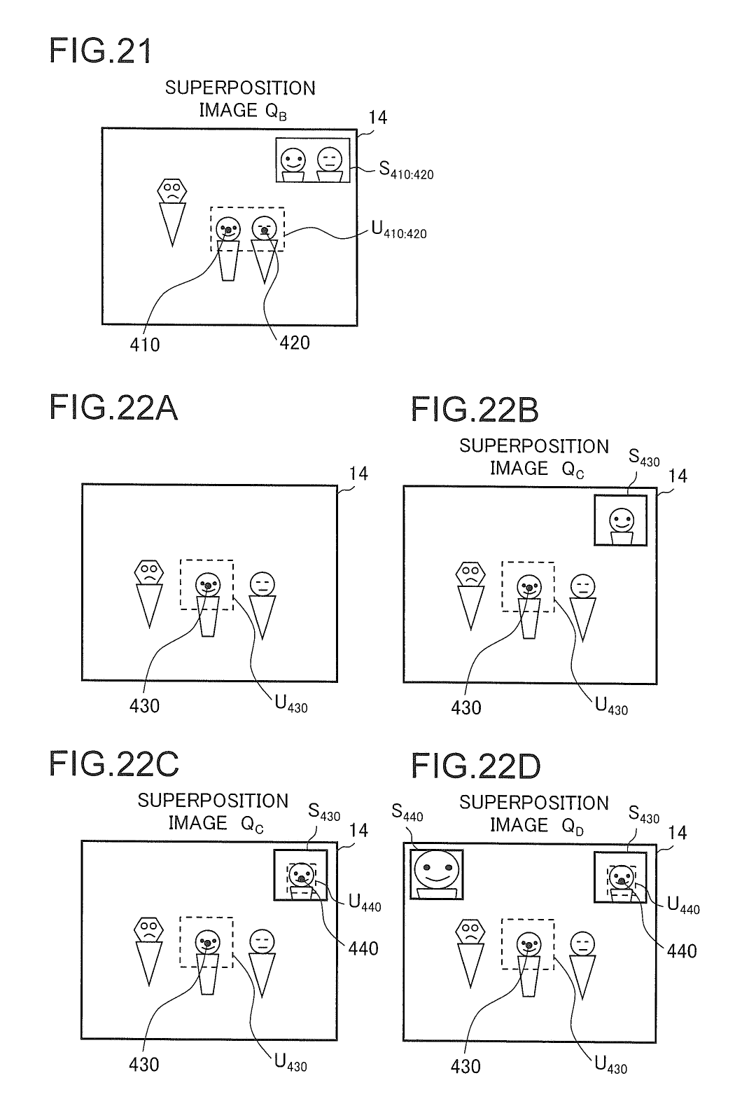

In addition, if a distance between the detected positions 410 and 420 on the reference image is short, it is possible to generate and superpose only one auxiliary image including the detected positions 410 and 420 (see FIG. 21). It is because it is considered that displaying one region including the detected positions 410 and 420 when the distance is short is easier to look, and a display area occupied by the auxiliary image can be small. In other words, for example, if the distance between the detected positions 410 and 420 on the reference image is larger than a predetermined distance, the output image processing portion 13 may perform the process of generating the superposition image Q_{A} as the output image as described above so as to display the superposition image Q_{A} on the display screen. On the other hand, if the distance between the detected positions 410 and 420 on the reference image is the predetermined distance or smaller, the output image processing portion 13 may perform the process of generating the superposition image Q_{B} as the output image so as to display the superposition image Q_{B} on the display screen. FIG. 21 illustrates a manner of the image display portion 14 displaying an example of the superposition image Q_{B}.

The process of generating the superposition image Q_{B} is described. The output image processing portion 13 sets an obtained region U_{410:420} including the detected positions 410 and 420 and extracts (generates) an auxiliary image S_{410:420} corresponding to the obtained region U_{410:420} from the reference image, in accordance with the above-mentioned method of setting the obtained region U and method of generating the auxiliary image S. The auxiliary image S_{410:420} is the image itself in the obtained region U_{410:420} of the reference image or an image obtained by enlarging or reducing the image. After that, the output image processing portion 13 sets a region for superposition different from the obtained region U_{410:420} (or the invisible region corresponding to the detected positions 410 and 420), and superposes the auxiliary image S_{410:420} on the region for superposition in the reference image so as to generate the superposition image Q_{B}.

Note that the examples of methods of generating the superposition images Q_{A} and Q_{B} are described above supposing that the number of detected positions of the pointing member is two, but the process described above can be applied also to the case where the number of detected positions is three or larger.

### Fifth Action Example

With reference to FIG. 22A and the like, a fifth action example of the output image processing portion 13 is described. FIG. 22A illustrates a manner in which the first output image without the auxiliary image S (i.e., the reference image) is displayed as the display image on the image display portion 14. In the fifth action example of the output image processing portion 13, it is supposed that when the display image based on the input image is displayed on the display screen, the user first puts the pointing member on (or close to) the position 430 on the display screen. As a result, the pointing member detecting portion 202 obtains the position 430 as the detected position.

The output image processing portion 13 sets the obtained region U₄₃₀ including the detected position 430 in accordance with the above-mentioned method of setting the obtained region U and method of generating the auxiliary image S, and extracts (generates) the auxiliary image S₄₃₀ corresponding to the obtained region U₄₃₀ from the reference image. In this case, the output image processing portion 13 performs a first enlarging process of enlarging an image I₄₃₀ in the obtained region U₄₃₀ of the reference image and generates the enlarged image I₄₃₀ as the auxiliary image S₄₃₀. After that, the output image processing portion 13 sets the region for superposition different from the obtained region U₄₃₀ (or the invisible region corresponding to the detected position 430) and superposes the auxiliary image S₄₃₀ on the region for superposition in the reference image so as to generate the superposition image Q_{C}. FIG. 22B illustrates a manner of the image display portion 14 displaying an example of the superposition image Q_{C}.

In the state where the superposition image Q_{C} including the auxiliary image S₄₃₀ is displayed as the display image on the display screen, as illustrated in FIG. 22C, it is supposed that the user further puts the pointing member on (or close to) the position 440 on the display screen. The position 440 is a position within the auxiliary image S₄₃₀ displayed on the display screen. When the position in the auxiliary image S₄₃₀ displayed on the display screen is detected as the detected position 440, the output image processing portion 13 sets the obtained region U₄₄₀ including the detected position 440 and extracts (generates) the auxiliary image S₄₄₀ corresponding to the obtained region U₄₄₀ from the reference image or the auxiliary image S₄₃₀. In this case, the output image processing portion 13 performs a second enlarging process of enlarging an image I₄₄₀ in the obtained region U₄₄₀ of the reference image or the auxiliary image S₄₃₀, and generates the enlarged image I₄₄₀ as the auxiliary image S₄₄₀. Viewing from the reference image, an image enlargement ratio of the auxiliary image S₄₄₀ is larger than that of the auxiliary image S₄₃₀. After that, the output image processing portion 13 sets the second region for superposition that is different from the region for superposition on which the auxiliary image S₄₃₀ is superposed and is also different from the obtained region U₄₃₀, and further superposes the auxiliary image S₄₄₀ on the second region for superposition in the superposition image Q_{C} including the auxiliary image S₄₃₀, so as to generate the superposition image (multi-superposition image) Q_{D}. FIG. 22D illustrates a manner of the image display portion 14 displaying an example of the superposition image Q_{D}.

In the state where the superposition image Q_{D} including the auxiliary images S₄₃₀ and S₄₄₀ is displayed, if the position in the auxiliary image S₄₃₀ or S₄₄₀ is further detected as the detected position of the pointing member, a third auxiliary image may be further generated and superposed (the same is true for forth and subsequent auxiliary images).

Because the image as illustrated in FIG. 22D can be displayed, the user can check details of the noted part in the limited display screen (it is possible to check the region in the auxiliary image S₄₃₀ in more detail by the auxiliary image S₄₄₀). However, the above-mentioned first and second enlarging processes can be omitted. In other words, for example, the output image processing portion 13 may generate the image I₄₃₀ itself in the obtained region U₄₃₀ or a reduced image of the image I₄₃₀ as the auxiliary image S₄₃₀, and may generate the image I₄₄₀ itself in the obtained region U₄₄₀ or a reduced image of the image I₄₄₀ as the auxiliary image S₄₄₀.

Note that when the superposition image including the auxiliary image S (S₄₃₀ or the like) is displayed on the display screen, if the position in the auxiliary image S on the display screen is designated by the pointing member, the process of the image processing execution portion 133 described above in the action example C1, C2 or the like (e.g., the process of removing the unnecessary object region) may be performed based on the designated position, and a result of the process may be reflected on display content of the display screen.

### Sixth Action Example

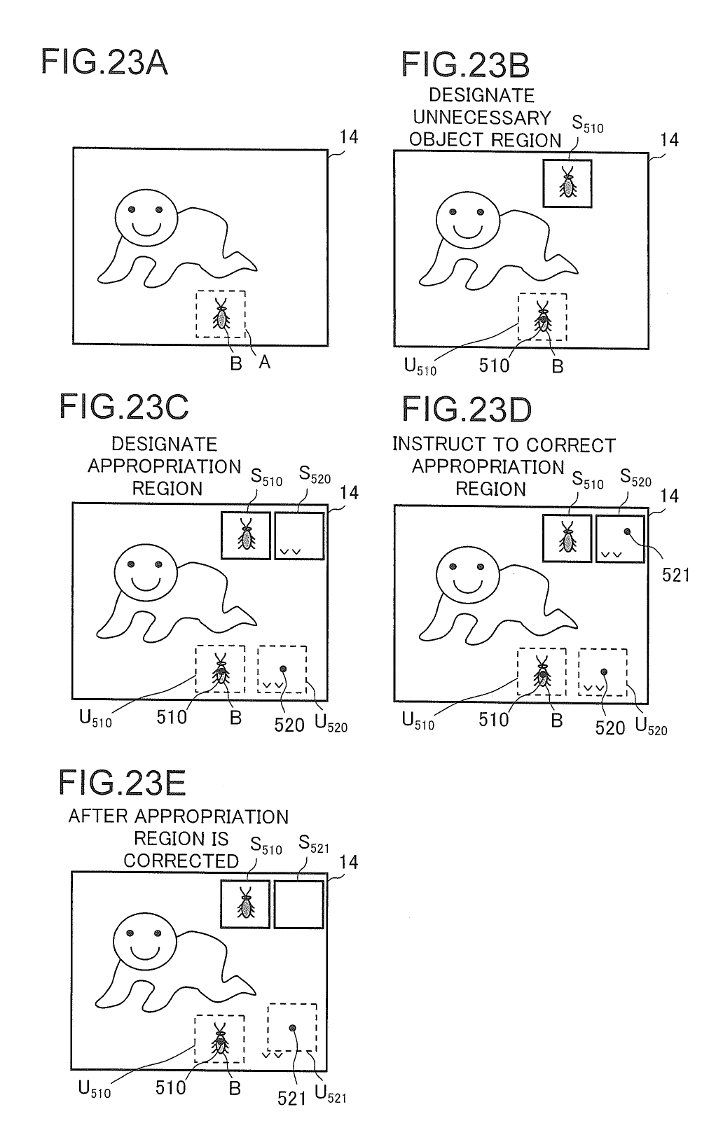

With reference to FIG. 23A and the like, a sixth action example of the output image processing portion 13 is described. FIG. 23A illustrates a manner in which the first output image without the auxiliary image S (i.e., the reference image) is displayed as the display image on the image display portion 14. In the sixth action example of the output image processing portion 13, it is supposed that the above-mentioned action example C1 is used (see FIG. 10, too), and it is further supposed that the similar region M1 and the appropriation region M2 for removing the unnecessary object region B are designated by the user. More specifically, when the display image based on the input image is displayed on the display screen, it is supposed that in order to designate the unnecessary object region B, the user puts the pointing member on (or close to) a position 510 on the display screen, and then in order to designate the similar region M1 and the appropriation region M2 for removing the unnecessary object region B, the user puts the pointing member on (or close to) a position 520 on the display screen (see FIGS. 23B and 23C). As a result, the pointing member detecting portion 202 can obtain the positions 510 and 520 as the detected positions.

When a plurality of detected positions 510 and 520 are obtained, as illustrated in FIGS. 23B and 23C, the output image processing portion 13 sets the obtained region U₅₁₀ including the detected position 510 and the obtained region U₅₂₀ including the detected position 520 sequentially in accordance with the method described above in the fourth action example, and extracts (generates) an auxiliary image S₅₁₀ including the detected position 510 and an auxiliary image S₅₇₀ including the detected position 520 from the reference image (input image). The obtained region U₅₁₀ and the auxiliary image S₅₁₀ both of which include the detected position 510 correspond to the process target region A, while the obtained region U₅₂₀ and the auxiliary image S₅₂₀ both of which include the detected position 520 correspond to the appropriation region M2 (see FIG. 10, too). When the auxiliary images S₅₁₀ and S₅₂₀ are generated, as described above in the fourth action example, the enlarging process or the reducing process of the image may be performed (the same is true for other auxiliary images described later). In accordance with the above-mentioned fourth action example, the output image processing portion 13 detects the position 510, and then generates the superposition image in which the auxiliary image S₅₁₀ is superposed on the reference image (FIG. 23B). Further, the output image processing portion 13 detects the position 520 and then can generate the superposition image in which the auxiliary images S₅₁₀ and S₅₂₀ are superposed on the reference image (FIG. 23C).

The user can check the process target region A and the appropriation region M2 by viewing the auxiliary images S₅₁₀ and S₅₂₀ (see FIG. 10, too). If there is a problem in these images, the user designates a position in the auxiliary image S₅₁₀ or S₅₂₀ by the pointing member so that the process target region A or the appropriation region M2 can be changed. Here, it is supposed that the user wants to change the appropriation region M2. In this case, the user puts the pointing member on (or close to) a position 521 in the auxiliary image S₅₂₀ on the display screen (see FIG. 22D). For example, the position 520 corresponds to the center position of the auxiliary image S₅₂₀, and the position 521 corresponds to the center position of an auxiliary image S₅₂₁ described later.

When a position in the auxiliary image S₅₂₀ displayed on the display screen is detected as the detected position 521, the output image processing portion 13 sets an obtained region U₅₂₁ including a detected position 521 instead of the obtained region U₅₂₀ including the detected position 520, and extracts the auxiliary image S₅₂₁ as an image in the obtained region U₅₂₁ including the detected position 521 from the reference image, so as to replace the auxiliary image S₅₂₀ displayed on the display screen with the auxiliary image S₅₂₁ (see FIG. 23E). In other words, based on the detected position 521 of the pointing member in the auxiliary image S₅₂₀, the output image processing portion 13 changes the auxiliary image to be superposed on the superposition image, the output image and the display image from the auxiliary image S₅₂₀ to the auxiliary image S₅₂₁ (change from FIG. 23D to FIG. 23E). In this case, the detected position 521 may be displayed clearly in a display region where the auxiliary image S₅₂₁ is not superposed (the dot 521 in FIG. 23E may be displayed).

In the state where the superposition image including the auxiliary images S₅₁₀ and S₅₂₁ is displayed, the obtained region U₅₁₀ and the auxiliary image S₅₁₀ both of which include the detected position 510 correspond to the process target region A, while the obtained region U₅₂₁ and the auxiliary image S₅₂₁ both of which include the detected position 521 correspond to the appropriation region M2. When the user performs a predetermined confirmation operation, the unnecessary object region B can be removed from the input image using the appropriation region M2 in accordance with the method described above in the action example C1. According to the sixth action example, position adjustment of the process target region A or the appropriation region M2 can be performed on the auxiliary image, and fine adjustment can be performed using the enlarged display of the auxiliary image. Note that the technique described above in the sixth action example can be used also in the case where the action example C1 is not used.

In addition, as described above as Related Art, there is considered a method in which a main screen and a sub screen are disposed independently in the display portion, and an image of one region in the main screen is displayed in the sub screen. In this method, it is considered that the entire display portion is the main screen at first stage without disposing the sub screen, and when the pointing member touches a specific position on the main screen (e.g., a noted person), the entire region of the display portion is sprit into a main screen region and a sub screen region so that an image of the designated part is displayed on the sub screen. However, in this case, a size of the main screen is reduced when the above-mentioned split is performed. Therefore, a subject corresponding to a contact position of the pointing member changes on the main screen between before and after the split is performed. For example, the noted person is displayed at the contact position before the split, while a building next to the noted person is displayed at the contact position after the split because a size of the main screen is reduced. Such a change of display is not desirable because it may upset the user. Therefore, the method of disposing the sub screen at all times is considered, but in this case, a size of the main screen is always small so that visibility of the entire image is deteriorated as described above.

<Variations>

As to the image pickup apparatus 1 according to the embodiment of the present invention, the action of the output image processing portion 13 may be performed by a control device such as a microcomputer. Further, all or some of the functions realized by the control device may be described as a program, and the program may be executed by a program execution device (e.g., a computer) so that all or some of the functions are realized.

In addition, without limiting to the above-mentioned case, the image pickup apparatus 1 illustrated in FIG. 1, the output image processing portion 13 illustrated in FIG. 3, and the image processing execution portion 133 illustrated in FIG. 12 can be realized by hardware or a combination of hardware and software. In addition, when a part of the image pickup apparatus 1, the output image processing portion 13, or the image processing execution portion 133 is realized using software, a block of a part realized by software indicates a functional block of the part.

Although the embodiment of the present invention is described above, the present invention is not limited to the embodiment, which can be modified variously within the scope of the invention without deviating from the spirit thereof.

The present invention can be used for an image display apparatus that displays an image. In addition, the present invention can be used for an image pickup apparatus that can display a taken image.

What is claimed is:

1. An image display apparatus comprising:
an image display portion that displays a display image based on a reference image on a display screen;
a pointing member detecting portion that detects a position of a pointing member existing on the display screen of the image display portion; and
an output image processing portion that generates an output image to be displayed on the display screen based on the reference image, wherein
the output image processing portion is capable of generating a superposition image as the output image, in which an auxiliary image including a specific region in the reference image corresponding to the position of the pointing member detected by the pointing member detecting portion is superposed on a region for superposition different from the specific region in the reference image.

2. The image display apparatus according to claim 1, wherein the output image processing portion generates the auxiliary image based on an obtained region including an invisible region displayed under the pointing member when the display image is displayed on the display screen, and is capable of generating the superposition image as the output image, in which the auxiliary image is superposed on the region for superposition different from the invisible region of the reference image.

3. The image display apparatus according to claim 1, wherein
the output image processing portion includes an image processing execution portion that performs a process based on the detected position of the pointing member on an input image, and
the output image processing portion is capable of generating the auxiliary image and the superposition image based on the reference image as the input image on which the process is performed.

4. The image display apparatus according to claim 3, wherein the image processing execution portion is capable of performing at least one of a process of changing a predetermined region in the input image, a process of adjusting image quality of a predetermined region in the input image, and a process of superposing an image for a user to operate an action of the apparatus on the input image.

5. The image display apparatus according to claim 1, further comprising an operating portion to be operated by a user, wherein
when the operating portion is operated, the output image processing portion regards detection results obtained sequentially by the pointing member detecting portion or a detection result obtained by the pointing member detecting portion before start of an operation of the operating portion to be valid.

6. The image display apparatus according to claim 5, wherein
when the operating portion is operated and when the pointing member detecting portion detects the pointing member existing on the display screen, the output image processing portion regards the detection results obtained sequentially by the pointing member detecting portion or a detection result obtained by the pointing member detecting portion when the operation of the operating portion is started to be valid, and
when the operating portion is operated and when the pointing member detecting portion detects that the pointing member does not exist on the display screen, the output image processing portion regards a detection result obtained by the pointing member detecting portion just before the pointing member existing on the display screen is detected or the detection result obtained by the pointing member detecting portion when the operation of the operating portion is started to be valid.

7. The image display apparatus according to claim 1, further comprising an operating portion to be operated by a user, wherein,
when the operating portion is operated, the output image processing portion regards a detection result obtained by the pointing member detecting portion after start of an operation of the operating portion to be invalid.

8. The image display apparatus according to claim 7, wherein
when the operating portion is operated and when the pointing member detecting portion detects the pointing member existing on the display screen, the output image processing portion regards a detection result obtained by the pointing member detecting portion when the pointing member detecting portion detects that the pointing member does not exist on the display screen or a detection result obtained by the pointing member detecting portion when the operation of the operating portion is started to be valid, and
when the operating portion is operated and when the pointing member detecting portion detects that the pointing member does not exist on the display screen, the output image processing portion regards the detection result obtained by the pointing member detecting portion when the pointing member detecting portion detects that the pointing member does not exist on the display screen or the detection result obtained by the pointing member detecting portion when the operation of the operating portion is started to be valid.

9. The image display apparatus according to claim 1, further comprising an operating portion to be operated by a user, wherein
based on at least one of whether or not the pointing member detecting portion detects the pointing member existing on the display screen and whether or not the operating portion is operated,
the output image processing portion determines whether or not to generate the superposition image as the output image.

10. The image display apparatus according to claim 9, wherein based on whether or not the pointing member detecting portion detects the pointing member existing on the display screen, the output image processing portion determines whether or not to generate the superposition image as the output image.

11. The image display apparatus according to claim 9, wherein based on whether or not the operating portion is operated, the output image processing portion determines whether or not to generate the superposition image as the output image.

12. The image display apparatus according to claim 9, wherein based on a detection result obtained by the pointing member detecting portion regarded to be valid by the output image processing portion based on whether or not the pointing member detecting portion detects the pointing member existing on the display screen and whether or not the operating portion is operated, the output image processing portion determines whether or not to generate the superposition image as the output image.

13. The image display apparatus according to claim 1, wherein the output image processing portion is capable of generating, as the output image, the superposition image in which a tag image indicating the detected position of the pointing member in the auxiliary image.

14. The image display apparatus according to claim 1, wherein the output image processing portion superposes the auxiliary image on the region for superposition of the reference image so as to generate the superposition image.

15. The image display apparatus according to claim 1, wherein when a plurality of positions are detected by the pointing member detecting portion,
the output image processing portion sets a plurality of specific regions corresponding to the plurality of detected positions so as to generate a plurality of auxiliary images corresponding to the plurality of specific regions from the reference image, and superposes the plurality of auxiliary images on a plurality of regions for superposition different from the specific regions of the reference image so as to generate the superposition image.

16. The image display apparatus according to claim 1, wherein when a plurality of positions are detected by the pointing member detecting portion,
the output image processing portion performs a first or second generation process selectively in accordance with a distance between the detected positions,
in the first generation process, the output image processing portion generates a single image including a region including the plurality of detected positions as the auxiliary image from the reference image, and superposes the auxiliary image on the region for superposition different from the region including the plurality of detected positions in the reference image so as to generate the superposition image, and
in the second generation process, the output image processing portion sets a plurality of specific regions corresponding to the plurality of detected positions so as to generate a plurality of auxiliary images including the plurality of specific regions from the reference image, and superposes the plurality of auxiliary images on a plurality of regions for superposition different from the plurality of specific regions in the reference image so as to generate the superposition image.

17. The image display apparatus according to claim 1, wherein when the superposition image in which the auxiliary image is superposed on the region for superposition is displayed as the output image and as the display image on the display screen, and when it is detected that the pointing member exists on the auxiliary image of the display screen,
the output image processing portion generates, from the reference image or the auxiliary image, a second auxiliary image including a region corresponding to the detected position of the pointing member on the auxiliary image, so as to generate a multi-superposition image as the output image, in which the second auxiliary image is further superposed on a second region for superposition different from the region for superposition in the superposition image.

18. The image display apparatus according to claim 1, wherein when the superposition image in which the auxiliary image is superposed on the region for superposition is displayed as the output image and as the display image on the display screen, and when it is detected that the pointing member exists on the auxiliary image of the display screen,
the output image processing portion changes the auxiliary image to be superposed on the superposition image, based on the detected position of the pointing member on the auxiliary image.
